(19) United States
(12) Patent Application Publication
(10) Pub. No.: US 2026/0082037 A1
(43) Pub. Date: Mar. 19, 2026

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Semih ESENLIK, Los Angeles, CA (US); Yaojun WU, Beijing (CN); Meng WANG, Beijing (CN); Zhaobin ZHANG, Los Angeles, CA (US); Kai ZHANG, Los Angeles, CA (US); Li ZHANG, Los Angeles, CA (US)

(21) Appl. No.: 19/335,640

(22) Filed: Sep. 22, 2025

Related U.S. Application Data
(63) Continuation of application No. PCT/CN2024/083422, filed on Mar. 22, 2024.
(60) Provisional application No. 63/511,013, filed on Jun. 29, 2023.

(30) Foreign Application Priority Data
Mar. 22, 2023 (WO) PCT/CN2023/082954
Apr. 7, 2023 (WO) PCT/CN2023/086991
Apr. 15, 2023 (WO) PCT/CN2023/088545

(51) Int. Cl. H04N 19/117; H04N 19/119; H04N 19/132; H04N 19/174; H04N 19/70

(52) U.S. Cl. CPC H04N 19/117; H04N 19/119; H04N 19/132; H04N 19/174; H04N 19/70

(57) ABSTRACT

Embodiments of the present disclosure provide a solution for visual data processing. A method for visual data processing is proposed. The method comprises: applying, based on a first component of visual data and for a conversion between the visual data and one or more bitstreams of the visual data with a neural network (NN)-based model, a filtering process on a second component of the visual data with at least one NN layer in the NN-based model, the first component being different from the second component; and performing the conversion based on a result of the applying.

### CROSS REFERENCE TO RELATED APPLICATIONS

This application is a continuation of International Application No. PCT/CN2024/083422, filed on Mar. 22, 2024, which claims the benefit of International Application No. PCT/CN2023/082954, filed on Mar. 22, 2023, International Application No. PCT/CN2023/086991, filed on Apr. 7, 2023, International Application No. PCT/CN2023/088545, filed on Apr. 15, 2023, and U.S. Provisional Application No. 63/511,013, filed on Jun. 29, 2023. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality of neural network-based image/video coding is generally expected to be further improved.

### SUMMARY

Embodiments of the present disclosure provide a solution for visual data processing.

In a first aspect, a method for visual data processing is proposed. The method comprises: applying, based on a first component of visual data and for a conversion between the visual data and one or more bitstreams of the visual data with a neural network (NN)-based model, a filtering process on a second component of the visual data with at least one NN layer in the NN-based model, the first component being different from the second component; and performing the conversion based on a result of the applying.

According to the method in accordance with the first aspect of the present disclosure, a filtering process is applied on a second component of the visual data based on a first component of the visual data. Compared with the conventional solution where the first and second components are processed independently, the proposed method can advantageously utilize the cross-component information to enhance the quality of the reconstructed visual data, and thus the coding quality can be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: applying, based on a first component of the visual data, a filtering process on a second component of the visual data with at least one NN layer in the NN-based model, the first component being different from the second component; and generating the bitstream based on a result of the applying.

In a fifth aspect, a method for storing a bitstream of visual data is proposed. The method comprises: applying, based on a first component of the visual data, a filtering process on a second component of the visual data with at least one NN layer in the NN-based model, the first component being different from the second component; and generating the bitstream based on a result of the applying; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1A illustrates a block diagram that illustrates an example visual data coding system, in accordance with some embodiments of the present disclosure.

FIG. 1B is a schematic diagram illustrating an example transform coding scheme.

FIG. 2 illustrates example latent representations of an image.

FIG. 3 is a schematic diagram illustrating an example autoencoder implementing a hyperprior model.

FIG. 4 is a schematic diagram illustrating an example combined model configured to jointly optimize a context model along with a hyperprior and the autoencoder.

FIG. 5 illustrates an example encoding process.

FIG. 6 illustrates an example decoding process.

FIG. 7 illustrates an example decoding process according to the present disclosure.

FIG. 8 illustrates an example learning-based image codec architecture.

FIG. 9 illustrates an example synthesis transform for learning based image coding.

FIG. 10 illustrates an example leaky relu activation function.

FIG. 11 illustrates an example relu activation function.

FIG. 12 illustrates an example convolution process to obtain component 1.

FIG. 13 illustrates an example convolution process to obtain component 1.

FIG. 14 illustrates an example convolution process to obtain component 1.

FIG. 15 illustrates an example convolution process to obtain component 1.

FIG. 16 illustrates an example convolution process to obtain component 1 and component 2.

FIG. 17 illustrates an example convolution process to obtain component 1 and component 2.

FIG. 18 illustrates an example convolution process to obtain component 1.

FIG. 19 illustrates an example convolution process to obtain component 1.

FIG. 20 illustrates an example convolution process to obtain component 1.

FIG. 21 illustrates an example layer structure of EFE.

FIG. 22 illustrates an example layer structure of EFE.

FIG. 23 illustrates an example of pixel shuffle and unshuffle operations.

FIG. 24 illustrates an example transposed convolution operation.

FIG. 25 illustrates an example subnetwork of a neural network.

FIG. 26 illustrates an example subnetwork of a neural network.

FIG. 27 illustrates an example subnetwork of a neural network.

FIG. 28 illustrates an example subnetwork of a neural network.

FIG. 29 illustrates an example of base weight (W_base[i,j]) values.

FIG. 30 illustrates an example of W_base[i,j] values.

FIG. 31 illustrates an example of W_base[i,j] values.

FIG. 32 illustrates an example of W_base[i,j] values.

FIG. 33 illustrates an example of W_base[i,j] values.

FIG. 34 illustrates an example of W_base[i,j] values.

FIG. 35 illustrates an example neural network.

FIG. 36 illustrates an example implementation of enhancement filtering extension layers.

FIG. 37 illustrates a flowchart of a method for visual data processing in accordance with embodiments of the present disclosure.

FIG. 38 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

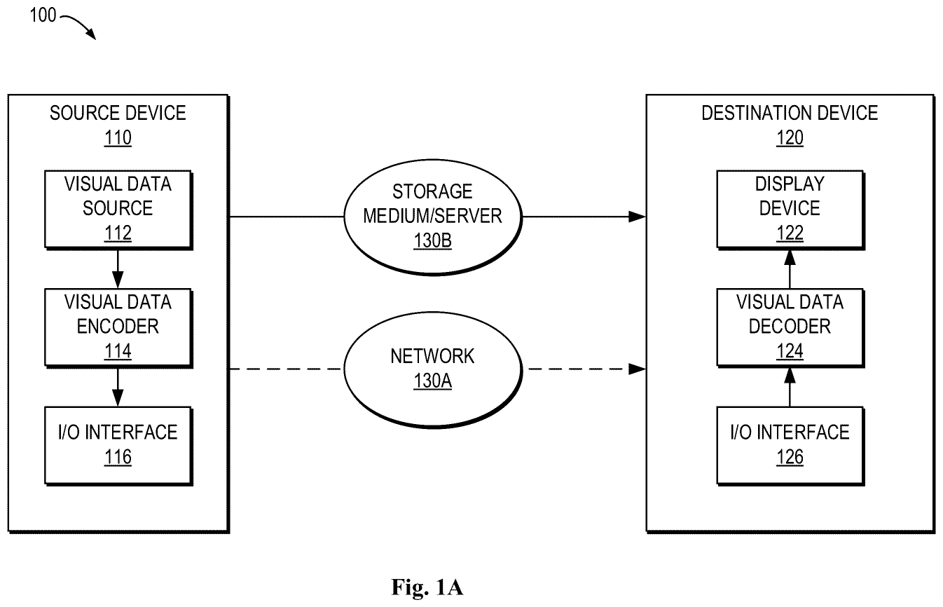

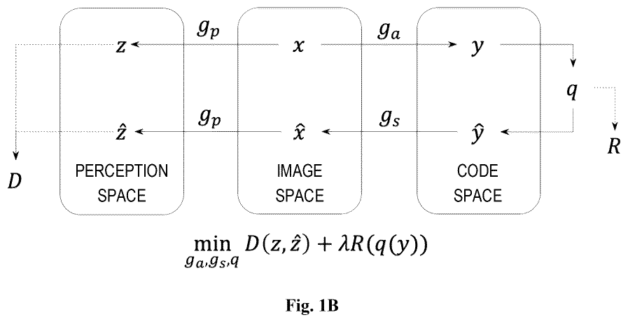

FIG. 1A is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. INITIAL DISCUSSION

This patent document is related to a neural network-based image and video compression approach employing modifications of components of an image using convolution layers. The weights of the convolution layer(s) are included in the bitstream. This patent document is further related to a neural network-based image and video compression approach employing a luma-aided adaptive chroma upsampling filter. An adaptive neural network based upsampling layer is proposed, wherein a first component is upsampled using information from a second component of an image.

### 2. FURTHER DISCUSSION

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks for Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit −log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁, x₂, . . . , xᵢ₋₁.

Most of the methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

FIG. 1B is a schematic diagram illustrating an example transform coding scheme. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image \hat{x}=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

### 2.3.3 Hyper Prior Model

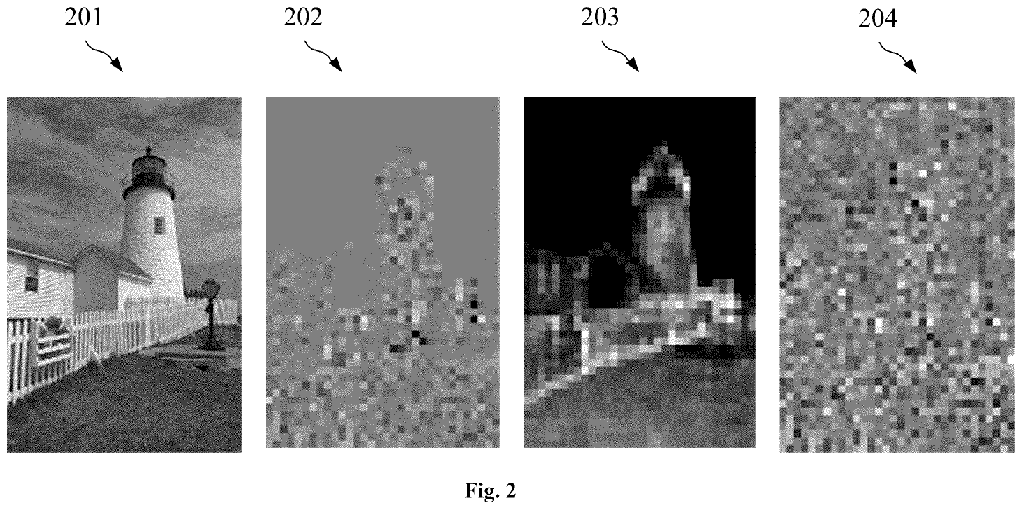

FIG. 2 illustrates example latent representations of an image. FIG. 2 includes an image 201 from the Kodak dataset, visualization of the latent 202 representation y of the image 201, a standard deviations σ 203 of the latent 202, and latents y 204 after a hyper prior network is introduced. A hyper prior network includes a hyper encoder and decoder. In the transform coding approach to image compression, as shown in FIG. 1B, the encoder subnetwork transforms the image vector x using a parametric analysis transform gₐ (x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

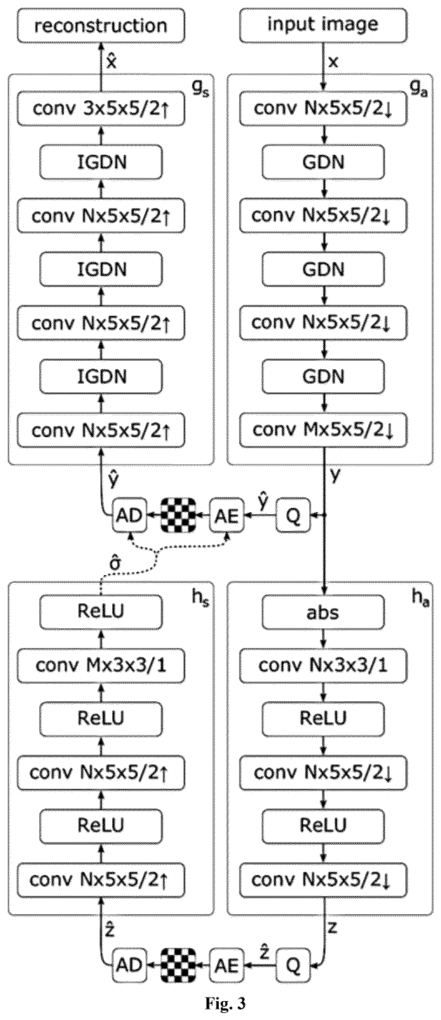

As evident from the latent 202 and the standard deviations σ 203 of FIG. 2, there are significant spatial dependencies among the elements of ŷ. Notably, their scales (standard deviations σ 203) appear to be coupled spatially. An additional set of random variables \hat{z} may be introduced to capture the spatial dependencies and to further reduce the redundancies. In this case the image compression network is depicted in FIG. 3.

FIG. 3 is a schematic diagram illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram of FIG. 3, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 204 in FIG. 2 correspond to the quantized latent when the hyper encoder/decoder are used. Compared to the standard deviations σ 203, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

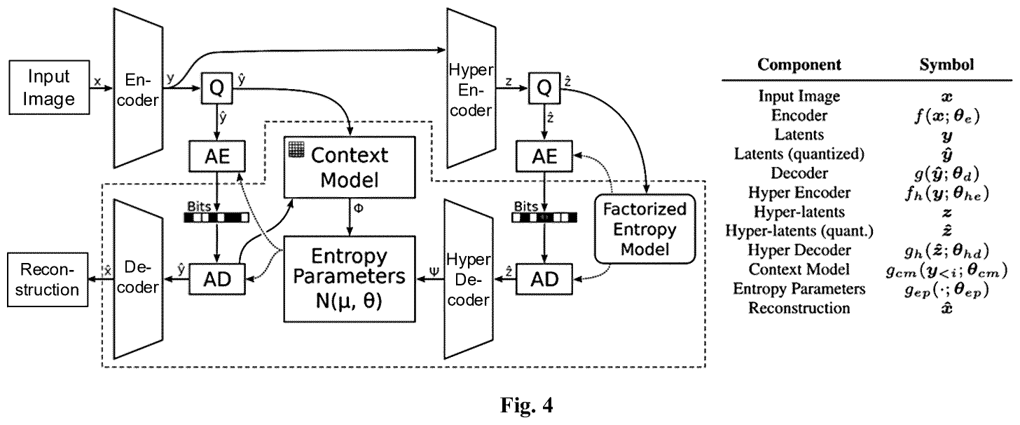

FIG. 4 is a schematic diagram illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyper prior model subnetwork (hyper encoder and hyper decoder) and a context model subnetwork are utilized. The hyper prior and the context model are combined to learn a probabilistic model over quantized latents ŷ, which is then used for entropy coding. As depicted in FIG. 4, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

In an example, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s}$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′∈R^{c*n}, which includes n inverse gain vectors, i.e., M′={δₛ₍₀₎, δₛ₍₁₎, . . . , δ_{s(c-1)}}, δₛ₍ᵢ₎∈R. The inverse gain process is expressed as:

$${y}_{s}^{′} = \hat{y} ⊙ {m}_{s}^{′}$$

where ŷ is the decoded quantized latent representation and yₛ′ is the inversely gained quantized latent representation, which will be fed into the synthesis network.

To achieve continuous variable rate adjustment, interpolation is used between vectors. Given two pairs of gain vectors

$$\{ {m}_{t} , {m}_{t}^{′} \} and \{ {m}_{r} , {m}_{r}^{′} \} ,$$

the interpolated gain vector can be obtained via the following equations.

$${m}_{ν} = [ {( {m}_{r} )}^{l} \cdot {( {m}_{t} )}^{1 - l} ]$$

$${m}_{ν}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.3.6 the Encoding Process Using Joint Auto-Regressive Hyper Prior Model

The design in FIG. 4. corresponds an example combined compression method. In this section and the next, the encoding and decoding processes are described separately.

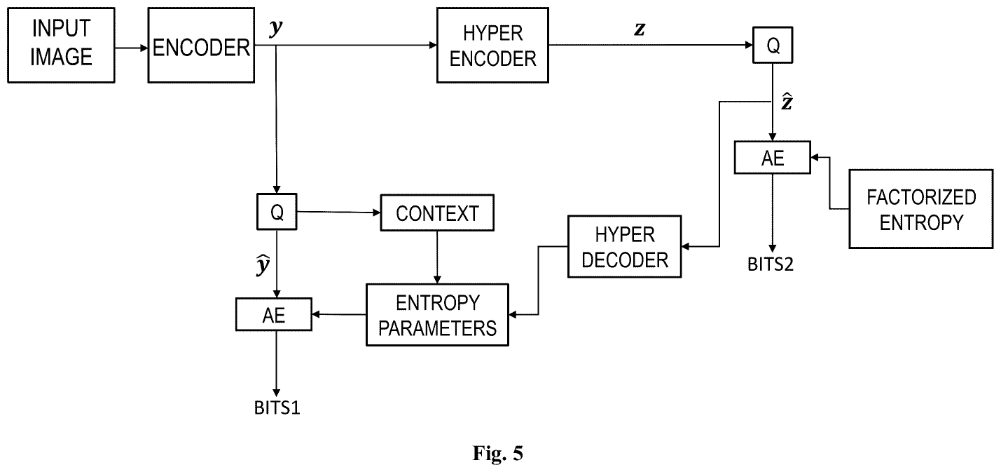

FIG. 5 illustrates an example encoding process. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent ŷ is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter a is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 5 are collectively called an encoder. The analysis transform that converts the input image into latent representation is also called an encoder (or auto-encoder).

### 2.3.7 The Decoding Process Using Joint Auto-Regressive Hyper Prior Model

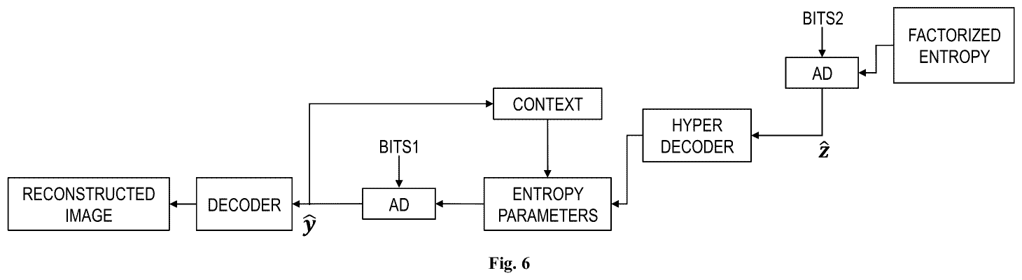

FIG. 6 illustrates an example decoding process. FIG. 6 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.5 Preliminaries

Almost all the natural image and/or video is in digital format. A grayscale digital image can be represented by x∈ [symbol] , where [symbol] is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference chroma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] . If m=1080, n=1920, | [symbol] |=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).
To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 2.6 Separate Processing of Luma and Chroma Components of an Image

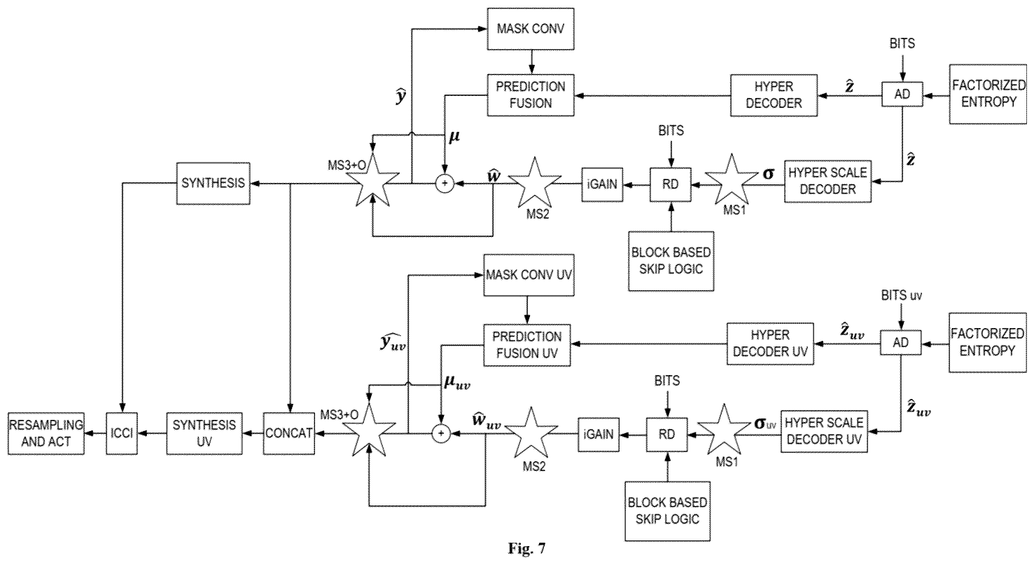

FIG. 7 illustrates an example decoding process according to the present disclosure.

According to one implementation, the luma and chroma components of an image can be decoded using separate subnetworks. In FIG. 7, the luma component of the image is processed by the subnetworks “Synthesis”, “Prediction fusion”, “Mask Conv”, “Hyper Decoder”, “Hyper scale decoder” etc. Whereas the chroma components are processed by the subnetworks: “Synthesis UV”, “Prediction fusion UV”, “Mask Conv UV”, “Hyper Decoder UV”, “Hyper scale decoder UV” etc.

A benefit of this separate processing is that the computational complexity of the processing of an image is reduced by application of separate processing. Typically, in neural network based image and video decoding, the computational complexity is proportional to the square of the number of feature maps. If the number of total feature maps is equal to 192 for example, computational complexity will be proportional to 192×192. On the other hand if the feature maps are divided into 128 for luma and 64 for chroma (in the case of separate processing), the computational complexity is proportional to 128×128+64×64, which corresponds to a reduction in complexity by 45%. Typically, the separate processing of luma and chroma components of an image does not result in a prohibitive reduction in performance, as the correlation between the luma and chroma components are typically very small.

The processing (Decoding process) in the above figure can be explained below:
1. Firstly, the factorized entropy model is used to decode the quantized latents for luma and chroma, i.e., \hat{z} and \hat{z}ᵤᵥ in FIG. 7.
2. The probability parameters (e.g. variance) generated by the second network are used to generate a quantized residual latent by performing the arithmetic decoding process.
3. The quantized residual latent is inversely gained with the inverse gain unit (iGain) as shown in orange color in FIG. 7. The outputs of the inverse gain units are denoted as ŵ and ŵᵤᵥ for luma and chroma components, respectively.
4. For the luma component, the following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
5. After all of the samples of ŷ are obtained, a synthesis transform can be applied to obtain the reconstructed image.
6. For chroma component, step 4 and 5 are the same but with a separate set of networks.
7. The decoded luma component is used as additional information to obtain the chroma component. Specifically, the Inter Channel Correlation Information filter sub-network (ICCI) is used for chroma component restoration. The luma is fed into the ICCI sub-network as additional information to assist the chroma component decoding.
8. Adaptive color transform (ACT) is performed after the luma and chroma components are reconstructed.

The module named ICCI is a neural-network based postprocessing module. The examples are not limited to the UCCI subnetwork. Any other neural network based postprocessing module might also be used.

An exemplary implementation of the disclosure is depicted in the FIG. 7 (the decoding process). The framework comprises two branches for luma and chroma components respectively. In each of the branches, the first subnetwork comprises the context, prediction and optionally the hyper decoder modules. The second network comprises the hyper scale decoder module. The quantized hyper latent are \hat{z} and \hat{z}ᵤᵥ. The arithmetic decoding process generates the quantized residual latents, which are further fed into the iGain units to obtain the gained quantized residual latents ŵ and ŵᵤᵥ.

After the residual latent is obtained, a recursive prediction operation is performed to obtain the latent ŷ and ŷᵤᵥ. The following steps describe how to obtain the samples of latent ŷ[:, i,j], and the chroma component is processed in the same way but with different networks.
1. An autoregressive context module is used to generate first input of a prediction module using the samples ŷ[:, m, n] where the (m, n) pair are the indices of the samples of the latent that are already obtained.
2. Optionally the second input of the prediction module is obtained by using a hyper decoder and a quantized hyper latent [symbol] .
3. Using the first input and the second input, the prediction module generates the mean value mean[:, i, j].
4. The mean value mean[:, i, j] and the quantized residual latent ŵ[:, i, j] are added together to obtain the latent ŷ[:, i, j].
5. The steps 1-4 are repeated for the next sample.

Whether to and/or how to apply at least one method disclosed in the document may be signaled from the encoder to the decoder, e.g. in the bitstream.

Whether to and/or how to apply at least one method disclosed in the document may be determined by the decoder based on coding information, such as dimensions, color format, etc.

Further, the modules named MS1, MS2 or MS3+O (in FIG. 7), might be included in the processing flow. The said modules might perform an operation to their input by multiplying the input with a scalar or adding an adding an additive component to the input to obtain the output. The scalar or the additive component that are used by the said modules might be indicated in a bitstream.

The module named RD or the module named AD in the FIG. 7 might be an entropy decoding module. It might be a range decoder or an arithmetic decoder or the like.

The examples described herein is not limited to the specific combination of the units exemplified in FIG. 7. Some of the modules might be missing and some of the modules might be displaced in processing order. Also, additional modules might be included. For example:
1. The ICCI module might be removed. In that case the output of the Synthesis module and the Synthesis UV module might be combined by means of another module, that might be based on neural networks.
2. One or more of the modules named MS1, MS2 or MS3+O might be removed. The core of the disclosure is not affected by the removing of one or more of the said scaling and adding modules.

In FIG. 7, other operations that are performed during the processing of the luma and chroma components are also indicated using the star symbol. These processes are denoted as MS1, MS2, MS3+O. These processing might be, but not limited to, adaptive quantization, latent sample scaling, and latent sample offsetting operations. For example, in an adaptive quantization process might correspond to scaling of a sample with multiplier before the prediction process, wherein the multiplier is predefined or whose value is indicated in the bitstream. The latent scaling process might correspond to the process where a sample is scaled with a multiplier after the prediction process, wherein the value of the multiplier is either predefined or indicated in the bitstream. The offsetting operation might correspond to adding an additive element to the sample, again wherein the value of the additive element might be indicated in the bitstream or inferred or predetermined.

Another operation might be tiling operation, wherein samples are first tiled (grouped) into overlapping or non-overlapping regions, wherein each region is processed independently. For example the samples corresponding to the luma component might be divided into tiles with a tile height of 20 samples, whereas the chroma components might be divided into tiles with a tile height of 10 samples for processing.

Another operation might be application of wavefront parallel processing. In wavefront parallel processing, a number of samples might be processed in parallel, and the amount of samples that can be processed in parallel might be indicated by a control parameter. The said control parameter might be indicated in the bitstream, be inferred, or can be predetermined. In the case of separate luma and chroma processing, the number of samples that can be processed in parallel might be different, hence different indicators can be signalled in the bitstream to control the operation of luma and chrome processing separately.

### 2.7 Colors Separation and Conditional Coding

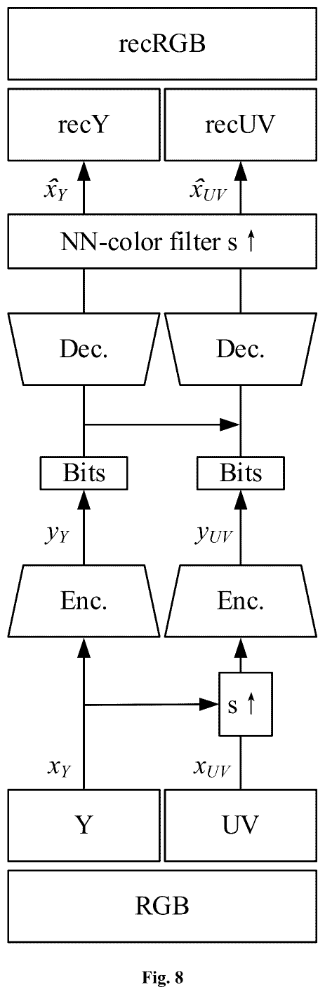

FIG. 8 illustrates an example learning-based image codec architecture.

In one example the primary and secondary color components of an image are coded separately, using networks with similar architecture, but different number of channels as shown in FIG. 8. All boxes with same names are sub-networks with the similar architecture, only input-output tensor size and number of channels are different. Number of channels for primary component is Cₚ=128, for secondary components is Cₛ=64. The vertical arrows (with arrowhead pointing downwards) indicate data flow related to secondary color components coding. Vertical arrows show data exchange between primary and secondary components pipelines.

The input signal to be encoded is notated as x, latent space tensor in bottleneck of variational auto-encoder is y. Subscript “Y” indicates primary component, subscript “UV” is used for concatenated secondary components, there are chroma components.

First the input image that has RGB color format is converted to primary (Y) and secondary components(UV). The primary component x_{Y} is coded independently from secondary components x_{UV} and the coded picture size is equal to input/decoded picture size. The secondary components are coded conditionally, using x_{Y} as auxiliary information from primary component for encoding x_{UV} and using ŷ_{Y} as a latent tensor with auxiliary information from primary component for decoding ŷ_{UV} reconstruction. The codec structure for primary component and secondary components are almost identical except the number of channels, size of the channels and the several entropy models for transforming latent tensor to bitstream, therefore primary and secondary latent tensor will generate two different bitstream based on two different entropy models. Prior to the encoding x_{Y}, x_{UV} goes through a module which adjusts the sample location by down-sampling (marked as “s↓” on FIG. 8), this essentially means that coded picture size for secondary component is different from the coded picture size for primary component. The scaling factor s is variable, but the default scaling factor is s=2. The size of auxiliary input tensor in conditional coding is adjusted in order the encoder receives primary and secondary components tensor with the same picture size. After reconstruction, the secondary component is rescaled to the original picture size with a neural-network based upsampling filter module (“NN-color filter s↑” on FIG. 8), which outputs secondary components up-sampled with factor s.

The example in FIG. 8 exemplifies an image coding system, where the input image is first transformed into primary (Y) and secondary components (UV). The outputs \hat{x}_{Y}, \hat{x}_{UV} are the reconstructed outputs corresponding to the primary and secondary components. At the and of the processing, \hat{x}_{Y}, \hat{x}_{UV} are converted back to RGB color format. Typically the x_{UV} is downsampled (resized) before processing with the encoding and decoding modules (neural networks). For example the size of the x_{UV} might be reduced by a factor of 50% in each of the vertical and horizontal dimensions. Therefore the processing of the secondary component includes approximately 50%×50%=25% less samples, therefore it is computationally less complex.

### 2.8 Cropping Operation in Neural Network Based Coding

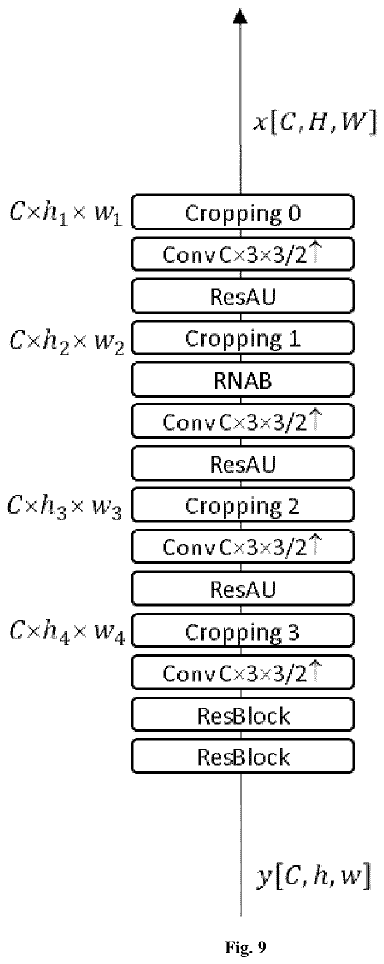

FIG. 9 illustrates an example synthesis transform for learning based image coding.

The example synthesis transform above includes a sequence of 4 convolutions with up-sampling with stride of 2. The synthesis transform sub-Net is depicted on FIG. 9. The size of the tensor in different parts of synthesis transform before cropping layer is the diagram on FIG. 9.

The cropping layer changes tensor size h_{d}×w_{d} to h_{d-1}×w_{d-1}, where h_{d}=2·ceil(H/2^{d}); w_{d}=2·ceil(W/2^{d}); here d is the depth of proceeding convolution in the codec architecture. For primary component Synthesis Transform receives input tensor with size h×w; h=ceil(H/16); w=ceil(W/16). The output of Synthesis Transform for primary component is 1×h₀×w₀, where h₀=H; h₀=W.

For secondary component Synthesis Transform receives input tensor with size h_{UV}×w_{UV}; h_{UV}=ceil(ceil(H/s)/16); w_{UV}=ceil(ceil(W/s)/16). The output of the Synthesis Transform for primary component is 2×h_{UV0}×w_{UV0}, where h_{UV0}=ceil(H/s); h_{UV0}=ceil(W/s). For secondary components input sizes are h₀=ceil(H/s); w₀=ceil(W/s), where s is the scale factor. The scale factor might be 2 for example, wherein the secondary component is downsampled by a factor of 2.

Based on the above explanation, the operation of the cropping layers depend on the output size H,W and the depth of the cropping layer. The depth of the left-most cropping layer in FIG. 9 is equal to 0. The output of this cropping layer must be equal to H, W (the output size), if the size of the input of this cropping layer is greater than H or W in horizontal or vertical dimension respectively, cropping needs to be performed in that dimension. The second cropping layer counting from left to right has a depth of 1. The output of the second cropping layer must be equal to h₁=2·ceil(H/21); w₁=2·ceil(W/21), which means if the input of this second cropping layer is greater than h1, w1 in any dimension, than cropping is applied in that dimension. In summary, the operation of cropping layers are controlled by the output size H,W. In one example if H and W are both equal to 16, then the cropping layers do not perform any cropping. On the other hand if H and W are both equal to 17, then all 4 cropping layers are going to perform cropping.

### 2.9 Bitwise Shifting

The bitwise shift operator can be represented using the function bitshift(x, n), where n is an integer number. If n is greater than 0, it corresponds to right-shift operator (>>), which moves the bits of the input to the right, and the left-shift operator (<<), which moves the bits to the left. In another words the bitshift(x, n) operation corresponds to:

$$bitshift ( x , n ) = x * {2}^{n} ,$$

$$or$$

$$bitshift ( x , n ) = floor ( x * {2}^{n} ) ,$$

$$or$$

$$bitshift ( x , n ) = x / / {2}^{n} .$$

The output of the bitshift operation is an integer value. In some implementations, the floor( ) function might be added to the definition.

Floor(x) is equal to the largest integer less than or equal to x.

The “//” operator or the integer division operator: It is an operation that comprises division and truncation of the result toward zero. For example, 7/4 and −7/−4 are truncated to 1 and −7/4 and 7/−4 are truncated to −1.

$$rightshift ( x , n ) = x >> n or$$

$$leftshift ( x , n ) = x << n$$

Equation 3: alternative implementation of the bitshift operator as rightshift or leftshift.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

### 2.10 Convolution Operation

The convolution operation starts with a kernel, which is a small matrix of weights. This kernel “slides” over the input data, performing an elementwise multiplication with the part of the input it is currently on, and then summing up the results into a single output pixel. In some cases, the convolution operation might comprise a “bias”, which is added to the output of the elementwise multiplication operation.

The convolution operation may be described by the following mathematical formula. An output out1 can be obtained as:

$$out 1 [ x , y ] = conv 1 ( I ) = {\sum }_{k = 0}^{M} {\sum }_{i = 0}^{N} {\sum }_{j = 0}^{P} w {1}_{k} [ i , j ] \times {I}_{k} [ x + i , y + j ] + K 1$$

where w1 are the multiplication factors, K1 is called a bias (an additive term), Iₖ is the kth input, N is the kernel size in one direction and P is the kernel size in another direction. The convolution layer might comprise convolution operations wherein more than one output might be generated. Other equivalent depictions of the convolution operation might be found below:

$$out 1 [ x , y ] = conv 1 ( I ) = {\sum }_{k = 0}^{M} {\sum }_{i = 0}^{N} {\sum }_{j = 0}^{P} w 1 [ k , i , j ] \times I [ k , x + i , y + j ] + K 1$$

$$out [ c , x , y ] = conv ( I ) = {\sum }_{k = 0}^{M} {\sum }_{i = 0}^{N} {\sum }_{j = 0}^{P} w [ c , k , i , j ] \times I [ k , x + i , y + j ] + K [ c ]$$

In the above equations “c” indicates the channel number. It is equivalent to output number, out[1,x,y] is one output and out[2,x,y] is a second output. The k is the input number, I[1, x, y] is one input, and I[2, x, y] is a second input. The w1, or w describe weights of the convolution operation.

### 2.11 Leaky_Relu Activation Function

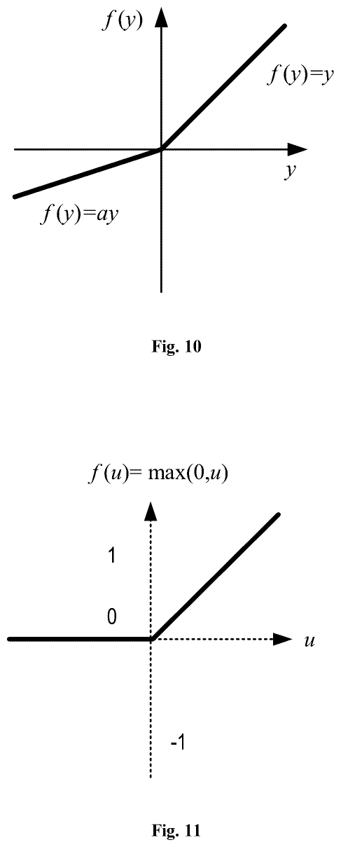

FIG. 10 illustrates an example leaky relu activation function. The leaky_relu activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the leaky relu function.

### 2.12 Relu Activation Function

FIG. 11 illustrates an example relu activation function. The leaky relu activation function is depicted in FIG. 11. According to the function, if the input is a positive value, the output is equal to the input. If the input (y) is a negative value, the output is equal to 0.

### 3. TECHNICAL PROBLEMS SOLVED BY DISCLOSED TECHNICAL SOLUTIONS

When the components of the image, e.g. a luma component and the chroma component, are processed with different synthesis subnetworks, the correlation between the different components are not fully utilized. In other words, information that might be important for reconstruction of one component might also be relevant for the reconstruction of a second component too. This joint information cannot be fully utilized when two different synthesis transforms are utilized for reconstruction of two different components.

### 4. A LISTING OF SOLUTIONS AND EMBODIMENTS

According to the disclosure, a subnetwork comprising a convolution layer is included at the end of the two synthesis transforms. The first synthesis transform processes the first component of an image and the second synthesis transform processes the second component. The subnetwork takes the output of the two subnetworks as input and improves at least one of the components.

### 4.1 Central Examples

A decoder operation may be performed as follows.

A bitstream is converted to a reconstructed image, comprising the following operations:
A synthesis transform is used to obtain a first component and a second component of an image.
First component and the second component are input to a convolution layer.
The convolution layer modifies at least one of the components.
The reconstructed image (decoded image) is obtained according to the two components.

In one example the synthesis transform is composed of two synthesis transforms, wherein the first component is obtained using the first synthesis transform and the second component is obtained using the second synthesis transform.

### 4.2 Details of the Examples

In some examples, the convolution layer might have the following details:
The convolution layer might have 2 at least 2 inputs.
   One input might be luma component.
   Second input might be chroma component.
The convolution layer might have 3 inputs, 1 luma and 2 chroma components.
The convolution layer might have 1 output, a chroma component.
The convolution layer might have 2 outputs, two chroma components.
The convolution layer might have 2 outputs, a luma and a chroma component.
The convolution layer might have 3 outputs, a luma and two chroma components.

In some examples, the operation performed by the convolution layer might have the following details:
In one example a mean value of the first component might be calculated, which is subtracted from the first component before inputting to the convolution layer.
A mean value of the second component might be calculated, which is subtracted from the second component before inputting to the convolution layer.
   In one example the mean value might be obtained from the bitstream.
   In another example the mean value can be predefined.
   In another example the mean value might be calculated by summing the samples of first or second component and dividing the result with the number of samples.
The calculated mean value might be added to an output of the convolution layer.
The output of the convolution layer might be one of the components.
At least one component of the image is modified by the convolution layer.
The output of the convolution layer might be added to the output of one of the synthesis transforms to obtain one of the processed components.
The component 1 (i.e. the output of the convolution layer might be obtained according to either one of the following formula:

$$Component 1 = conv ( in 2 - E ( in 2 ) , in 1 - E ( in 1 ) ) + in 1 + K$$

$$Component 1 = conv ( in 2 , in 1 - E ( in 1 ) ) + in 1 + K$$

$$Component 1 = conv ( in 2 - E ( in 1 ) , in 1 ) + K$$

$$Component 1 = conv ( in 2 , in 1 ) + K$$

$$Component 1 = conv ( in 2 , in 1 - E ( in 1 ) ) + E ( in 1 ) + K$$

$$Component 1 = conv ( in2 - E ( in 2 ) , in 1 - E ( in 1 ) ) + E ( in 1 ) + K$$

$$Component 1 = conv ( in 2 - E ( in 2 ) ) + in 1 + K$$

$$Component 1 = conv ( in 2 - E ( in 2 ) ) + in 1$$

wherein in1 and in2 are the two components of the image that are obtained as output of the synthesis transform, E(in1) is the mean value of the in1, K is an additive parameter. In one example K is equal to zero. In another example K is a scalar whose value is signaled in a bitstream.
In one particular example the chroma U component might be obtained according to chroma U and luma inputs (components).
In another particular example the chroma V component might be obtained according to chroma V and luma inputs (components).
In another particular example the luma component might be obtained according to only luma input (component).
According to the disclosure different modified components of the image might be obtained using the convolution layer according to different number of inputs:
   In one particular example the chroma U component might be obtained according to chroma U and luma inputs.
   In another particular example the chroma V component might be obtained according to chroma V and luma inputs.
   In another particular example the luma component might be obtained according to only luma input.
   The number of inputs that are used might be indicated in the bitstream. For example for obtaining chroma U component, either 1 input (e.g. only luma component) or two inputs (e.g. luma and chroma U component) might be used. The selection might be indicated in the bitstream.
   An indicator might be included in the bitstream to indicate which input is used to obtain an output. For example according to the value of the indicator either luma component or chroma U component might be used as input to obtain the chroma U output.
The formula that is used to obtain a component might be indicated in the bitstream. For example according to the indicator either one or both of the of the outputs of the 2 synthesis transforms might be used. More specifically, if the output of Synthesis transform 1 is out1, and output of Synthesis transform 2 is out2, then according to the value of the indicator, either only out1 or both of out1 and out2 might be used as input to the convolution layer.
   In one example the component 1 might be obtained either according to Component1=conv(in2−E(in2))+in1+K or according to conv(in2−E(in2), in1−E(in1))+in1+K based on the value of an indicator that is obtained from the bitstream.
   In one example an indicator is included in the bitstream to indicate how many inputs are used to obtain one component. For example chroma U component might be obtained according to one input and chroma V component can be obtained according to 2 inputs. The indicator indicates how many inputs are used in obtaining an output component.
The kernel size of the convolution operation might be indicated in the bitstream.
The weights (the multiplier parameters) of the convolution operation might be included (and obtained from) a bitstream.
   In one example the weights of the convolution might be included in the bitstream using N bits.
      N might be adjustable and an indication controlling N might be included in the bitstream. For example according to an indication in the bitstream, the value of N might be inferred to be equal to 16. Or the value of N might be inferred to be equal to 12.
The output of the synthesis transforms might be tiled into multiple tiles. Different convolution weights might be applied at different tiles. In other words different convolution weights might be obtained from the bitstream corresponding to different tiles.
   In one example the number of tiles might be signaled in the bitstream.
   The number of tiles might be different for each component.

Examples of the operation performed by the convolution layer are depicted in the examples below.

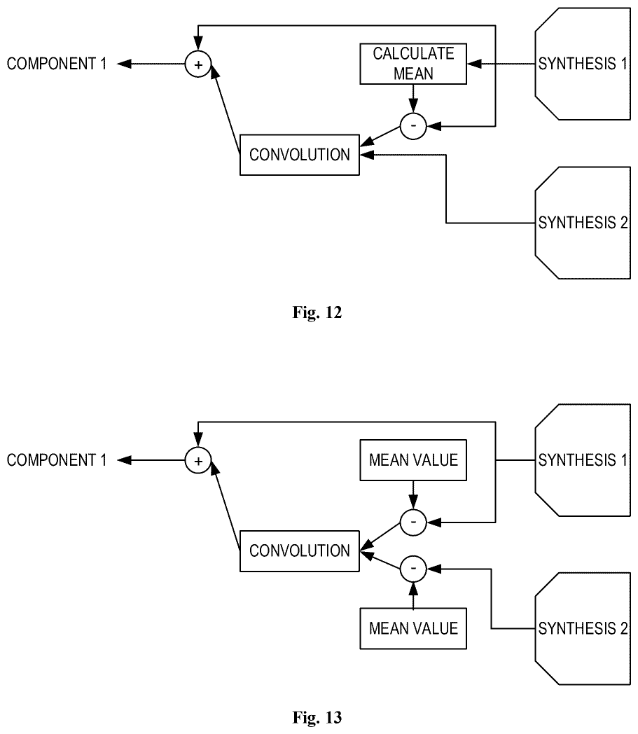

FIG. 12 illustrates an example convolution process to obtain component 1.

FIG. 13 illustrates an example convolution process to obtain component 1.

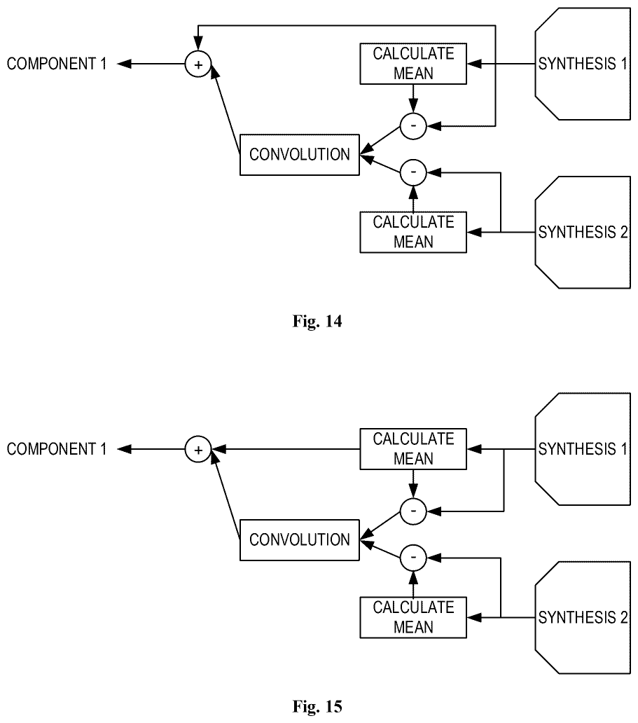

FIG. 14 illustrates an example convolution process to obtain component 1.

FIG. 15 illustrates an example convolution process to obtain component 1.

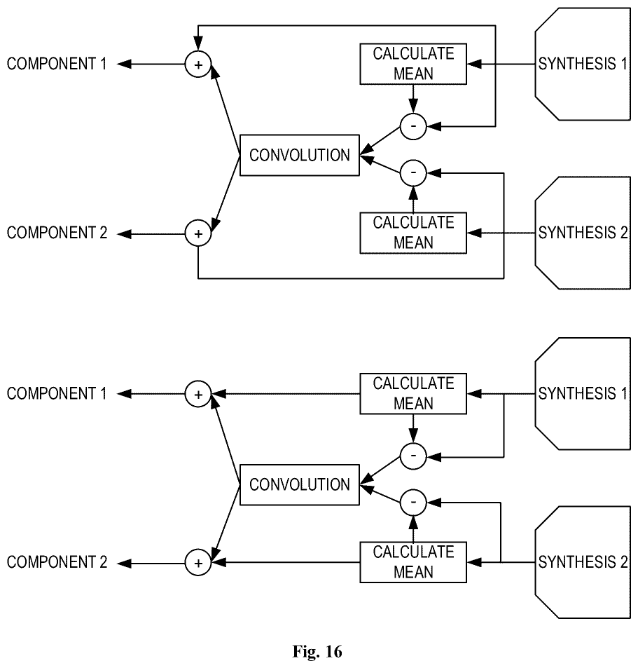

FIG. 16 illustrates an example convolution process to obtain component 1 and component 2.

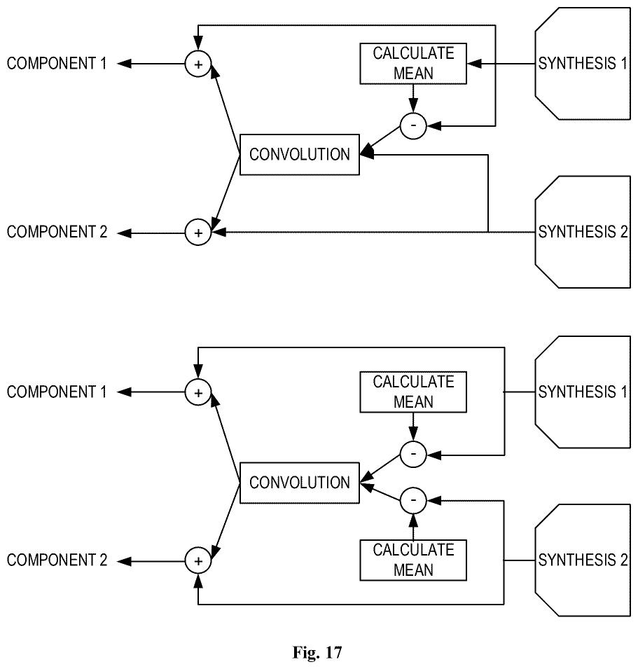

FIG. 17 illustrates an example convolution process to obtain component 1 and component 2.

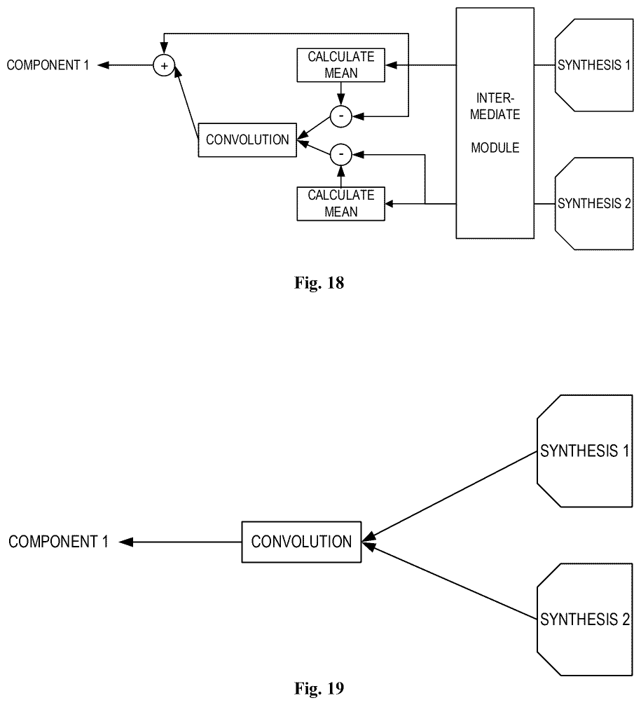

FIG. 18 illustrates an example convolution process to obtain component 1.

FIG. 19 illustrates an example convolution process to obtain component 1.

In the example depicted in FIG. 12, a mean value is first calculated based on the output of Synthesis transform 1 (out1). The mean value (mean1) is subtracted from the output of the Synthesis transform 1. The output of Synthesis transform 2 (out2) and (out1−mean1) is fed to convolution layer. The output of the convolution layer is added to out1 to obtain Component 1. The reconstructed image (decoded image) is obtained according to Component 1. In this example the out1 and out2 denote the output of synthesis transform 1 and 2.

In FIG. 14, in addition to the example in FIG. 12 a second mean value (mean2) is calculated based on the output of Synthesis transform 2 (out2). (Out1−mean1) and (out2−mean2) are fed to convolution. Out1 is added to the output of convolution layer to obtain Component 1.

The example in FIG. 13 is similar to FIG. 14. The difference between the two examples is that, in FIG. 13 the mean value is obtained from a bitstream or is predefined. Using a mean value that is predefined or that is obtained from a bitstream has the advantage of reducing the computational complexity, as the calculation of mean value does not need to be performed. When the mean value is obtained from the bitstream, it means that the mean value was calculated at the encoder and included in the bitstream. Therefore, the decoder can obtain the mean value from the bitstream and perform the convolution operation.

The FIGS. 16 and 17 depict the examples where the output of the convolution layer are component 1 and component 2.

The example depicted in FIG. 15 is similar to FIG. 14. In the example in FIG. 15, the component 1 is obtained by adding the calculated mean value (instead of the output of synthesis transform 1) to the output of the convolution layer.

In some examples, the details of the components might be as follows.
One component might be a chroma component and one component might be a luma component.
The output of the first synthesis transform might be luma component. And the output of the second synthesis transform might be chroma U and Chroma V components. In other example the output of the second synthesis transform might be chroma Cb and chroma Cr components.
In another example the components might be R, G and B components (e.g. Red, Green and Blue).

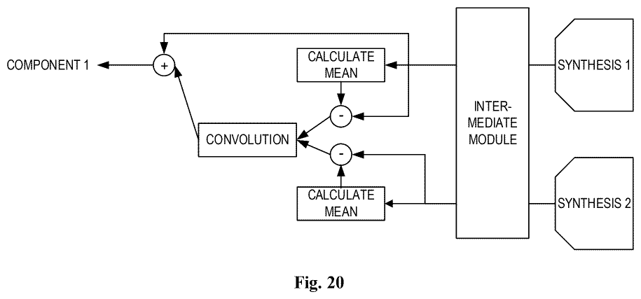

FIG. 20 illustrates an example convolution process to obtain component 1.

The FIG. 20 exemplifies an aspect of the disclosure, wherein an intermediate module is places between the convolution operation and the synthesis transforms. In any of the above examples, the conv(A, B) is equivalent to conv(A)+conv(B). According to one example, a component is modified according to one of the following formula:

$$Component 1 = ( in 1 - mean ) * r + mean ,$$

$$Component 1 = ( in 1 - mean ) / r + mean ,$$

$$Component 1 = ( in 1 - mean ) * r + mean + K ,$$

$$Component 1 = ( in 1 - mean ) / r + mean + K ,$$

$$Component 1 = conv ( in 1 - mean ) + mean + K .$$

Wherein the mean and r are mean values and scale factors that might be obtained from a bitstream. In the decoder values of the mean and r might be obtained from a bitstream. The weights (coefficients) of the convolution might be obtained from the bitstream.

At the encoder, the mean value might be computed as the mean value of one of the components of the input image. And at the encoder r might be selected as a scale factor. The scale factor helps stretching the histogram of the input component, so that more details are preserved after quantization process of encoding. Depending on the value of r, more information might be preserved after quantization at encoder, with the cost of increased bitrate. The encoder might select r in such a way to strike a desired balance between bitrate and amount of retained information after quantization.

At the decoder histogram stretching performed by encoder is reversed according to the values of mean and r. The mean and r values are determined by encoder and included in the bitstream. Those values are obtained from the bitstream by the decoder to perform the reverse operation.

The section A below provides an example implementation of the proposed solutions. In the example the FIG. 20 depicts an example network structure, and subsection A.2 provides details about each processing layer. The subsection A.3 depicts an example method of signalling the parameters in the bitstream. The subsection A.4 depicts the semantics corresponding to the parameters in subsection A.3. Finally, the subsection A.5 depicts an example method of tiling the input image into multiple rectangular shaped regions (tiles) for processing. When tiling is applied, different weights and bias parameters might be used in different parts of the input.

### Section A Enhancement Filtering Extension (EFE) Layers

### A.1 General

This Annex details the Enhancement Filtering Extension Layers (EFE) process. This process provides enhancement of colour information planes (secondary components) of image utilising information from brightness (primary component).

### A.2 Layer Structure

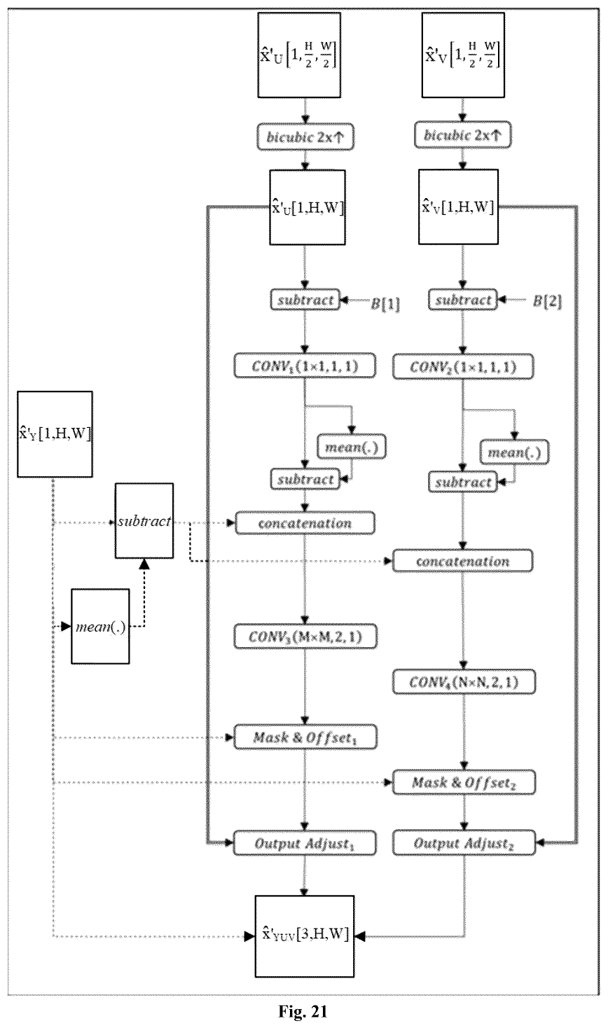

EFE sub-network module receives \hat{x}′_{UV} [2, H/2, W/2] and \hat{x}′_{Y}[1, H, W] as inputs and outputs full size enhanced \hat{x}′_{YUV} [3, H, W](FIG. 21). The first component \hat{x}′_{U}[1, H/2, W/2] goes through the bicubic 2x↑, CONV₁(1×1, 1, 1), CONV₃(M×M, 2, 1), Mask & Offset₁ and Output Adjust₁ processing layers in that order. The second component \hat{x}′_{V}[1, H/2, W/2] goes through the bicubic 2x↑, CONV₂(1×1, 1, 1), CONV₄(M×M, 2, 1), Mask & Offset₂ and Output Adjust₂ processing layers in that order. The FIG. 21 depicts the details of the layer structure.

FIG. 21 illustrates an example layer structure of EFE. The details of each layer are as follows:
CONV₁(1×1, 1, 1): The weight tensor is set to W₁ and the bias tensor is set to B[1].
CONV₂(1×1, 1, 1): The weight tensor is set to W₂ and the bias tensor is set to B[2].
CONV₃(M×M, 2, 1), the weight tensor is set to W₃, and the bias tensor is set to all zeros.
CONV₄(N×N, 2, 1), the weight tensor is set to W₄, and the bias tensor is set to all zeros.

$$Mask \& {Offset}_{z} , with z possible values of \{ 1 , 2 \} :$$

$$out [ 1 , x , y ] = in [ 1 , x , y ] + {\sum }_{n = 0}^{Q - 1} mask [ n , x , y ] * {C}_{Z} [ n ]$$

$$output {adjust}_{1} :$$

$$out [ 1 , x , y ] = ( {\hat{x}}_{U}^{′} [ 1 , x , y ] * {S}_{1} [ \frac{x}{b S} , \frac{y}{b S} ] + in [ 1 , x , y ] * ( 1 - {S}_{1} [ \frac{x}{b S} , \frac{y}{b S} ] ) ) \div 2$$

$$output {adjust}_{2} :$$

$$out [ 1 , x , y ] = ( {\hat{x}}_{V}^{′} [ 1 , x , y ] * {S}_{2} [ \frac{x}{b S} , \frac{y}{b S} ] + in [ 1 , x , y ] * ( 1 - {S}_{2} [ \frac{x}{b S} , \frac{y}{b S} ] ) ) \div 2$$

### Wherein;

$$mask [ n , x , y ] :$$

$$mask [ n , x , y ] = \{ \begin{matrix}1 , & \begin{matrix}{\hat{x}}_{Y}^{′} [ 1 , x , y ] > min ( {\hat{x}}_{Y}^{′} ) + n * gap ⋀ \\ {\hat{x}}_{Y}^{′} [ 1 , x , y ] \leq min ( {\hat{x}}_{Y}^{′} ) + ( n + 1 ) * gap\end{matrix} \\ 0 , & otherwise\end{matrix}$$

$$and gap = max ( {\hat{x}}_{Y}^{′} ) - min ( {\hat{x}}_{Y}^{′} ) ) \div Q$$

mean(.) outputs mean sample value of the input tensor.

$$out = ( {\sum }_{x = 0}^{H} {\sum }_{y = 0}^{W} in [ 1 , x , y ] ) \div ( H \times W )$$

subtract: the input on the side branch is subtracted from the input from the main branch, as exemplified below.

$$out [ 1 , x , y ] = in [ 1 , x , y ] - B [ 1 ]$$

concatenation: The two inputs are concatenated in channel dimension.

### A.3 Parameters Signalling

In order to perform the processing steps described in sections I.1 and I.2, the adjustable weight, bias and offset parameters are signalled in the picture header. The parameters that are signalled in the picture header are:
Weight and bias of the CONV₁(1×1, 1, 1) and CONV₁(1×1, 1, 1) operations: W₁[1], W₂[1], B[2].
kernel size and weights of the CONV₃ (M×M, 2, 1) and CONV₄ (N×N, 2, 1) operations: N, M, W₃ [2, M, M], W₄[2, N, N].
number of offsets and the offset values for Mask & Offset₁ and Mask & Offset₂ operations: Q, C₁[Q], C₂[Q].
block size and adjustment weights of the output adjust₁ and output adjust₂ operations: Bs,

$${S}_{1} [ \frac{H}{b S} , \frac{W}{b S} ] ,$$

$${S}_{2} [ \frac{H}{b S} , \frac{W}{b S} ] .$$

wP is set equal to 17.

| EFE_parameters( ) { | Descriptor |
|---|---|
| EFE_enabled_flag | uf(1) |
| if (EFE_enabled_flag) { | |
| best_cand_u_idx | uf(15) |
| best_cand_v_idx | uf(15) |
| if(best_cand_u_idx > 0) | |
| fl_V | uf(5) |
| if(best_cand_u_idx > 0) | |
| fl_U | uf(5) |
| for (idx = 0, idx < cand[best_cand_u_idx][1] , idx ++) | |
| for (i = 0, i < fl_U, i++) | |
| for (j = 0, j < fl_U, j++) | |
| A1 | uf(2^{WP}-1) |
| A2 | uf(2^{WP}-1) |
| WU[0,idx,i,j] = deinteger(A1,wP) | |
| WU[1,idx,i,j] = deinteger(A2,wP) | |
| for (idx = 0, idx < cand[best_cand_v_idx][1] , idx ++) | |
| for (i = 0, i < fl_V, i++) | |
| for (j = 0, j <fl_V, j++) | |
| A1 | uf(2^{WP}-1) |
| A2 | uf(2^{WP}-1) |
| WV[0,idx,i,j] = deinteger(A1,wP) | |
| WV[1,idx,i,j] = deinteger(A2,wP) | |
| bS | uf(2¹⁰-1) |
| len_mask_1_x | uf(2¹⁰-1) |
| len_mask_1_y | uf(2¹⁰-1) |
| len_mask_2_x | uf(2¹⁰-1) |
| len_mask_2_y | uf(2¹⁰-1) |
| A1 | uf(2¹⁵-1) |
| B[1] = A1÷100 | |
| A1 | uf(2¹⁵-1) |
| B[2] = A1÷100 | |
| A1 | uf(2¹⁵-1) |
| W₁[1] = A1÷1000 | |
| A1 | uf(2¹⁵-1) |
| W₂[1]= A1÷1000 | |
| for (i = 0, i < len_mask_1_x , i++) | |
| for (j = 0, i < len_mask_1_y, j++) | |
| S_{1[}i,j] | uf(3) |
| for (i = 0, i < len_mask_2_x , i++) | |
| for (j = 0, i < len_mask_2_y, j++) | |
| S₂[i,j] | uf(3) |
| Q | uf(2¹⁶-1) |
| for (i = 0, i < Q/2, i++) | |
| A1 | uf(2^{WP}-1) |
| C₁[i] = deinteger(A1) | |
| for (i = 0, i < Q/2, i++) | |
| A1 | uf(2^{WP}-1) |
| C₂[i] = deinteger(A1) | |
| } | |
| } | |

### A.4 Parameter Semantics

best_cand_u_idx—the 4 bit non-negative integer value specifying the candidate index corresponding to the u-component (first one of the secondary components), indicating the number of tiles and the tile coordinates. It is used as input to cand [X][Y] table in section I.5.
best_cand_v_idx—the 4 bit non-negative integer value specifying the candidate index corresponding to the v-component (second one of the secondary components), indicating the number of tiles and the tile coordinates. It is used as input to cand [X][Y] table in section I.5.
fl_U—the 6-valued non-negative integer value specifying the kernel size of the CONV₃(M×M, 2, 1) processing layer, i.e. the M=fl_U.
fl_V—the 6-valued non-negative integer value specifying the kernel size of the CONV₄(N×N, 2, 1) processing layer, i.e. the N=fl_V.
WU—the 4-dimensional tensor specifying the multiplier coefficients, e.g. weights, of the CONV₃(M×M, 2, 1) processing layer.
WV—the 4-dimensinal tensor specifying the multiplier coefficients, e.g. weights, of the CONV₄(N×N, 2, 1) processing layer.
bS—the 10 bit non-negative integer value specifying the block size of the output adjust₁ and output adjust₂ processing layers.
len_mask_1_x—the 10 bit non-negative integer value specifying the number of elements in the vertical direction of the S₁ tensor.
len_mask_1_y—the 10 bit non-negative integer value specifying the number of elements in the horizontal direction of the S₁ tensor.
len_mask_2_x—the 10 bit non-negative integer value specifying the number of elements in the vertical direction of the S₂ tensor.
len_mask_2_y—the 10 bit non-negative integer value specifying the number of elements in the horizontal direction of the S₂ tensor.
B[1]—the 16 bit value specifying the bias (additive component) of the CONV₁(1×1, 1, 1) processing layer.
B[2]—the 16 bit value specifying the bias (additive component) of the CONV₂(1×1, 1, 1) processing layer.
W₁—the 16 bit value specifying the weight (multiplicative component) of the CONV₁(1×1, 1, 1) processing layer.
W₂—the 16 bit value specifying the weight (multiplicative component) of the CONV₂(1×1, 1, 1) processing layer.
S₁—the 3-valued non-negative integer specifying the multiplication coefficients of the output adjust₁ processing layer.
S₂—the 3-valued non-negative the multiplication coefficients of the output adjust₂ processing layer.
C₁—the wP bit value specifying the additive offset parameters used in Mask & Offset₁ processing layer.
C₂—the wP bit value specifying the additive offset parameters used in Mask & Offset₂ processing layer.

### A.5 Tiling

The weights of the CONV₃(M×M, 2, 1) and CONV₄(N×N, 2, 1) operations, namely W₃[2, M, M] and W₄[2, N, N], are set based on the spatial coordinates of the sample that is processed. In other words rectangular tiling can be in the processing of the samples of the input. If the spatial coordinates of the sample being processed in (x,y), then the setting of the weight parameters are performed as:

```
Index = 0
For (i=0, i<cand[best_cand_u_idx][1],i++)
  If round(cand[best_cand_u_idx][2+i][0]*H) <y and y ≤ round(cand[best_cand_u_idx][2+i][1]*H)
    If round(cand[best_cand_u_idx][2+i][2]*W) <x and x ≤ round(cand[best_cand_u_idx][2+i][3]*W)
      Index = i
        W₃ [2, M, M] = WU[2, index, M, M]
Index = 0
For (i=0, i<cand[best_cand_v_idx][1],i++)
  If round(cand[best_cand_v_idx][2+i][0]*H) <y and y ≤ round(cand[best_cand_v_idx][2+i][1]*H)
    If round(cand[best_cand_v_idx][2+i][2]*W) <x and x ≤ round(cand[best_cand_v_idx][2+i][3]*W)
      Index = i
        W₄ [2, N, N] = WV[2, index, N, N]
```

The cand[X][Y][4] table that is referred to in sections I.3 and I.4 include the number of tiles and the coordinates of the tiles.

| cand | | | | | | | |
|---|---|---|---|---|---|---|---|
| [X][Y] | Y = 1 | Y = 2 | Y = 3 | Y = 4 | Y = 5 | Y = 6 | Y = 7 |
| X = 1 | 1 | [0, 1, 0, 1] | | | | | |
| X = 2 | 2 | [0, 0.5, 0, 1] | [0.5, 1, 0, 1] | | | | |
| X = 3 | 2 | [0, 1, 0, 0.5] | [0, 1, 0.5, 1]] | | | | |
| X = 4 | 3 | [0, 1, 0, 0.33] | [0, 1, 0.33, 0.66] | [0, 1, 0.66, 1] | | | |
| X = 5 | 3 | [0, 0.33, 0, 1] | [0.33, 0.66, 0,1] | [0.66, 1, 0, 1] | | | |
| X = 6 | 4 | [0, 0.5, 0, 0.5] | [0, 0.5, 0.5, 1] | [0.5, 1, 0, 0.5] | [0.5, 1, 0.5, 1] | | |
| X = 7 | 6 | [0, 0.33, 0, 0.5] | [0, 0.33, 0.5, 1] | [0.33, 0.66, 0, 0.5] | [0.33, 0.66, 0.5, 1] | [0.66, 1, 0, 0.5] | [0.66, 1, 0.5, 1] |
| X = 8 | 6 | [0, 0.5, 0, 0.33] | [0.5, 1, 0, 0.33] | [0, 0.5, 0.33, 0.66] | [0.5, 1, 0.33, 0.66] | [0, 0.5, 0.66, 1] | [0.5, 1, 0.66, 1] |

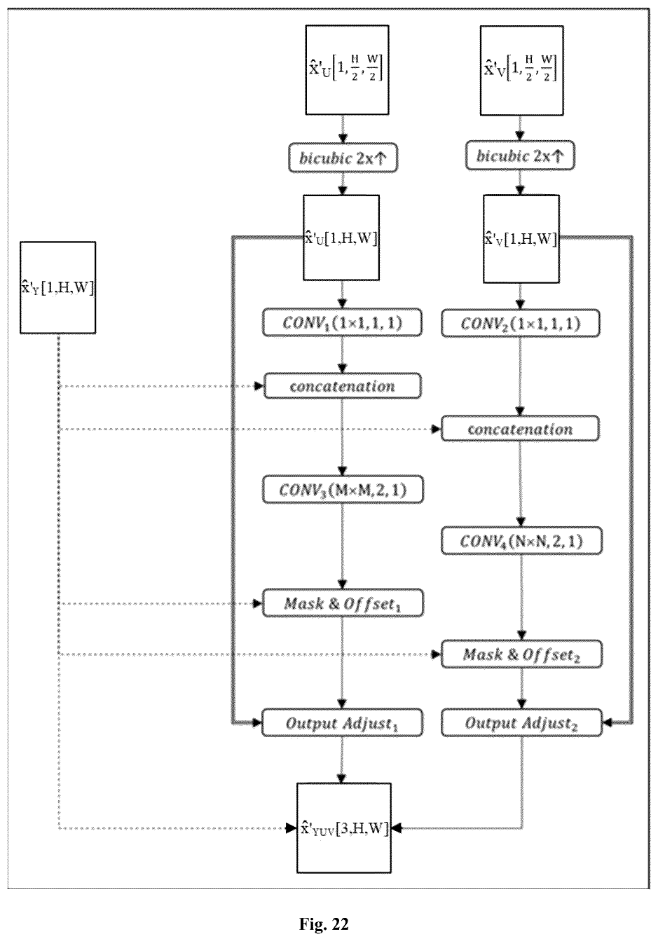

FIG. 22 illustrates an example layer structure of EFE.

Another example implementation of the proposed solutions is depicted in FIG. 22. Compared to the example in FIG. 21, In this example the subtract operations are removed.

### Section B Alternative Signalling Example

### B.1 Parameters Signalling

In order to perform the processing steps described in sections I.1 and I.2, the adjustable weight, bias and offset parameters are signalled in the picture header. The parameters that are signalled in the picture header are:
weight and bias of the CONV₁(1×1, 1, 1) and CONV₁(1×1, 1, 1) operations: W₁[1], W₂[1], B[2].
kernel size and weights of the CONV₃(M×M, 2, 1) and CONV₄(N×N, 2, 1) operations: N, M, W₃[2, M, M], W₄[2, N, N].
number of offsets and the offset values for Mask & Offset₁ and Mask & Offset₂ operations: Q, C₁[Q], C₂[Q].
block size and adjustment weights of the output adjust₁ and output adjust₂ operations: Bs,

$${S}_{1} [ \frac{H}{b S} , \frac{W}{b S} ] ,$$

$${S}_{2} [ \frac{H}{b S} , \frac{W}{b S} ] .$$

| EFE_parameters( ) { | Descriptor | row |
|---|---|---|
| EFE_enabled_flag | uf(1) | 1 |
| if (EFE_enabled_flag) { | | 2 |
| best_cand_u_idx | uf(15) | 3 |
| best_cand_v_idx | uf(15) | 4 |
| if(best_cand_u_idx > 0) | | 5 |
| fl_V | uf(9) | 6 |
| if(best_cand_u_idx > 0) | | 7 |
| fl_U | uf(9) | 8 |
| minSymbol | uf(2¹⁷-1) | 9 |
| maxSymbol | uf(2¹⁷-1) | 10 |
| for (idx = 0, idx < cand[best_cand_u_idx][1] , idx ++) | | 11 |
| for (i = 0, i < fl_U, i++) | | 12 |
| for (j = 0, j < fl_U, j++) | | 13 |
| A1 | uf(maxSymbol) | 14 |
| A2 | uf(maxSymbol) | 15 |
| WU[0,idx,i,j] = deinteger(A1+minSymbol,wP) | | 16 |
| WU[1,idx,i,j] = deinteger(A2+minSymbol,wP) | | 17 |
| for (idx = 0, idx < cand[best_cand_v_idx][1] , idx ++) | | 18 |
| for (i = 0, i < fl_V, i++) | | 19 |
| for (j = 0, j < fl_V,j++) | | 20 |
| A1 | uf(maxSymbol) | 21 |
| A2 | uf(maxSymbol) | 22 |
| WV[0,idx,i,j] = deinteger(A1+minSymbol,wP) | | 23 |
| WV[1,idx,i,j] = deinteger(A2+minSymbol,wP) | | 24 |
| mask1_enabled_flag | uf(1) | 25 |
| mask2_enabled_flag | uf(1) | 26 |
| len_mask_1_x =0, len_mask_2_x = 0, len_mask_1_y = 0, len_mask_2_y = 0 | | 27 |
| if (mask1_enabled_flag OR mask2_enabled_flag){ | | 28 |
| bS | | 29 |
| len_mask_x | uf(2¹⁰-1) | 30 |
| len_mask_y | uf(2¹⁰-1) | 31 |
| if mask1_enabled_flag{ | | 32 |
| len_mask_1_x = len_mask_x | | 33 |
| len_mask_1_y = len_mask_y | | 34 |
| } | | 35 |
| if mask2_enabled_flag{ | | 36 |
| len_mask_2_x = len_mask_x | | 37 |
| len_mask_2_y = len_mask_y | | 38 |
| } | | 39 |
| } | | 40 |
| A1 | uf(2¹⁵-1) | 41 |
| B[1] = A1÷100 | | 42 |
| A1 | uf(2¹⁵-1) | 43 |
| B[2] = A1÷100 | | 44 |
| A1 | uf(2¹⁵-1) | 45 |
| W₁[1] = A1÷1000 | | 46 |
| A1 | uf(2¹⁵-1) | 47 |
| W₂[1]= A1÷1000 | | 48 |
| for (i = 0, i < len_mask_1_x , i++) | | 49 |
| for (j = 0, i < len_mask_1_y, j++) | | 50 |
| S₁[i,j] | uf(3) | 51 |
| for (i = 0, i < len_mask_2_x , i++) | | 52 |
| for (j = 0, i < len_mask_2_y, j++) | | 53 |
| S₂[i,j] | uf(3) | 54 |
| Q | uf(2¹⁶-1) | 55 |
| for (i = 0, i < Q/2, i++) | | 56 |
| A1 | uf(maxSymbol) | 57 |
| C₁ [i] = deinteger(A1 + minSymbol) | | 58 |
| for (i = 0, i < Q/2, i++) | | 59 |
| A1 | uf(maxSymbol) | 60 |
| C₂[i] = deinteger(A1 + minSymbol) | | 61 |
| } | | 62 |
| } | | 63 |

### B.2 Parameter Semantics

best_cand_u_idx—the 4 bit non-negative integer value specifying the candidate index corresponding to the u-component (first one of the secondary components), indicating the number of tiles and the tile coordinates. It is used as input to cand [X][Y] table in section I.5.
best_cand_v_idx—the 4 bit non-negative integer value specifying the candidate index corresponding to the v-component (second one of the secondary components), indicating the number of tiles and the tile coordinates. It is used as input to cand [X][Y] table in section I.5.
fl_U—the 6-valued non-negative integer value specifying the kernel size of the CONV₃(M×M, 2, 1) processing layer, i.e. the M=fl_U.
fl_V—the 6-valued non-negative integer value specifying the kernel size of the CONV₄(N×N, 2, 1) processing layer, i.e. the N=fl_V.
WU—the 4-dimensional tensor specifying the multiplier coefficients, e.g. weights, of the CONV₃(M×M, 2, 1) processing layer.
WV—the 4-dimensional tensor specifying the multiplier coefficients, e.g. weights, of the CONV₄(N×N, 2, 1) processing layer.
bS—the 10 bit non-negative integer value specifying the block size of the output adjust₁ and output adjust₂ processing layers.
minSymbol—the 17-bit non-negative integer value specifying the a value that is added to multiplier coefficients WU, WV and offset parameters C₁ and C₂.
maxSymbol—the 17-bit non-negative integer value specifying a maximum value that is used in the uf( ) decoding process of multiplier coefficients WU, WV and offset parameters C₁ and C₂.
mask1_enabled_flag—the 1-bit non-negative integer value specifying a if the values of len_mask_1_x and len_mask_1_y are zero or greater than zero.
mask2_enabled_flag—the 1-bit non-negative integer value specifying a if the values of len_mask_2_x and len_mask_2_y are zero or greater than zero.
len_mask_1_x—the 10 bit non-negative integer value specifying the number of elements in the vertical direction of the S₁ tensor.
len_mask_1_y—the 10 bit non-negative integer value specifying the number of elements in the horizontal direction of the S₁ tensor.
len_mask_2_x—the 10 bit non-negative integer value specifying the number of elements in the vertical direction of the S₂ tensor.
len_mask_2_y—the 10 bit non-negative integer value specifying the number of elements in the horizontal direction of the S₂ tensor.
B[1]—the 16 bit value specifying the bias (additive component) of the CONV₁(1×1, 1, 1) processing layer.
B[2]—the 16 bit value specifying the bias (additive component) of the CONV₂(1×1, 1, 1) processing layer.
W₁—the 16 bit value specifying the weight (multiplicative component) of the CONV₁(1×1, 1, 1) processing layer.
W₂—the 16 bit value specifying the weight (multiplicative component) of the CONV₂(1×1, 1, 1) processing layer.
S₁—the 3-valued non-negative integer specifying the multiplication coefficients of the output adjust₁ processing layer.
S₂—the 3-valued non-negative integer specifying the multiplication coefficients of the output adjust₂ processing layer.
C₁—the wP bit value specifying the additive offset parameters used in Mask & Offset₁ processing layer.
C₂—the wP bit value specifying the additive offset parameters used in Mask & Offset₂ processing layer.

In section B, an alternative method of signalling the parameters of the convolution and filtering operations are presented. In the syntax table, the uf( ) operator is depicted. The definition of the uf(operation is as follows:
uf(x): The syntax element is coded using a uniform probability distribution. The minimum value of the distribution is 0, while its maximum value is x.
   According to the proposed solutions,
first a maximum value and/or a minimum value is included in (or decoded from) the bitstream. These are depicted as minSymbol and maxSymbol in section B1 above (row numbers 9 and 10). These values are first coded into (or decoded from) the bitstream to indicate a range of values that some of the following syntax elements might assume.
Following the minSymbol and maxSymbol in coding order, syntax elements might be coded (decoded) according to the value of the maxSymbol.
The value of minSymbol might be added to the coded (decoded) value.

For example in section B1, in row 16, weights of convolution operation WU[0,idx,i,j] are obtained as follows:
Firstly a syntax element A1 is obtained according to the value of the maxSymbol. This is depicted in uf(maxSymbol). The syntax element A1 is obtained according to a maximum value of maxSymbol. The maximum value that A1 can assume is maxSymbol.
Additionally or alternatively the minSymbol is added to A1, and the weight of the convolution parameter is obtained according to A1+minSymbol. This is depicted in row 16.

In another example in section B1, in row 58, the offset parameter C₁[i] is obtained as follows:
Firstly a syntax element A1 is obtained according to the value of the maxSymbol. This is depicted in uf(maxSymbol) in row 57. The syntax element A1 is obtained according to a maximum value of maxSymbol. The maximum value that A1 can assume is maxSymbol.
Additionally or alternatively the minSymbol is added to A1, and the offset parameter C₁[i] is obtained according to A1+minSymbol. This is depicted in row 18.

The benefit of using a minimum value (minSymbol) and/or maximum value (maxSymbol) is coding of the convolution weight parameters or offset parameters is that, it allows adaptation to content. In some images that are compressed, the value of convolution parameters and offset parameters might fall into a small range. In those cases the value of maxSymbol might be small. Much less side information need to be transmitted in coding of syntax elements that can assume a set of values in a small range. On the other hand there might be images where the value of syntax elements might not fall into a small range, and hence maxSymbol might be increased. In those cases more side information need to be transmitted. The proposed solution allows bitrate savings when the image to be codded result in syntax elements whose values fall into a small range of values.

At the encoder side, the encoder can estimate the values of minSymbol and/or maxSymbol by calculating the minimum and maximum values of all the syntax elements that are codded according to minSymbol and/or maxSymbol. For example in section B1, the minSymbol might be obtained according to minimum of all values of WU[0,idx,i,j] or WV[0,idx,i,j]. Or it might be according to the minimum value of all values of C₁[i]. Similarly maxSymbol might be obtained according to maximum value of all values of WU[0,idx,i,j] or WV[0,idx,i,j]. Or it might be according to the maximum value of all values of C₁[i].

According to the proposed solutions, a flag is included in the bitstream to indicate whether a mask operation is performed on a component or not. For example mask1_enabled_flag (row 25 in section B1) is included in the bitstream to indicate if a masking process is enabled or not. If mask1_enabled_flag is true, number of samples of the mask in horizontal and vertical direction (row 30 and 31) might be included in the bitstream. Alternatively or additionally a block size (bS, e.g. row 29) might be included in the bitstream if mask1_enabled_flag is true.

In another example 2 flags mask1_enabled_flag and mask2_enabled_flag might be included in the bitstream to indicate if a mask operation is enabled for a first component and a second component respectively. If at least one of the flags are true (e.g. the check in row 28) at the one of the following is included in the bitstream:
A block size,
Number of mask elements in a vertical direction (e.g. len_mask_y),
Number of mask elements in a horizontal direction (e.g. len_mask_x).

### 5. EMBODIMENTS

1. Decoder/encoder embodiment:
   An image or video decoding or encoding method, comprising a neural subnetwork, that comprise the following:
      Obtaining a first component and a second component of an image, based on a bitstream,
      Processing the two components with a convolution layer modifying at least one of the components, wherein the weights of the convolution layer are obtained from a bitstream,
      Obtaining the reconstructed image based on the two components at least one of which is modified.
2. According to the embodiment above;
   The first and the second components are obtained according to a synthesis transform.
3. According to the second embodiment;
   The first component is obtained using a first synthesis transform and the second component is obtained using a second synthesis transform.
4. According to any of the embodiments above, processing the two components with a convolution layer comprises:
   First obtaining a mean value of at least one of the first or second component,
   Subtracting the mean value from the said at least one component before processing with the convolution layer.
5. According to any of the embodiments above, processing the two components with a convolution layer to obtain a modified component1 comprises either one of the following:

$$Component 1 = conv ( i n 2 - E ( i n 2 ) , in 1 - E ( i n 1 ) ) + i n 1 + K$$

$$Component 1 = conv ( in 2 , in 1 - E ( i n 1 ) ) + i n 1 + K$$

$$Component 1 = con v ( i n 2 - E ( i n 1 ) , in 1 ) + K$$

$$Component 1 = conv ( in 2 , in 1 ) + K$$

$$Component 1 = conv ( in 2 , in 1 - E ( i n 1 ) ) + E ( i n 1 ) + K$$

$$Component 1 = con v ( i n 2 - E ( i n 2 ) , in 1 - E ( i n 1 ) ) + E ( i n 1 ) + K$$

$$Component 1 = con v ( i n 2 - E ( i n 2 ) ) + i n 1 + K$$

$$Component 1 = con v ( i n 2 - E ( i n 2 ) ) + i n 1$$

wherein in1 is the unmodified component 1 before convolution layer, in2 is the unmodified component 2, conv(describes the convolution operation, K is a scalar, EQ is a mean operation.
6. According to embodiment 5, the K is equal to 0.
7. According to any of the embodiments above, the convolution layer might have 2 or more outputs (e.g. modified component1, modified component 2, modified component 3 etc).

### 6. FURTHER SOLUTIONS

### 6.1 Dimensional Convolution Operation

The convolution operation can be defined in 1, 2, 3, 4, . . . dimensions. As an example the 2D convolution operation can be defined as:

$$out 1 [ x , y ] = conv 1 ( I ) = {\sum }_{i = 0}^{N} {\sum }_{j = 0}^{P} w {1}_{k} [ i , j ] \times {I}_{k} [ x + i , y + j ] + K 1$$

### 6.2 LeakyReLU Activation Function

FIG. 10 illustrates an example LeakyReLU activation function. The LeakyReLU activation function is depicted in FIG. 10. According to the function, if the input is a positive value, the output is equal to the input. If the input (y) is a negative value, the output is equal to a*y. The a is typically (not limited to) a value that is smaller than 1 and greater than 0. Since the multiplier a is smaller than 1, it can be implemented either as a multiplication with a non-integer number, or with a division operation. The multiplier a might be called the negative slope of the LeakyReLU function.

### 6.3 ReLU Activation Function

FIG. 11 illustrates an example ReLU activation function. The ReLU activation function is depicted in FIG. 11. According to the function, if the input is a positive value, the output is equal to the input. If the input (y) is a non-positive value, the output is equal to 0.

### 6.4 Pixel Shuffle and Unshuffle Functions

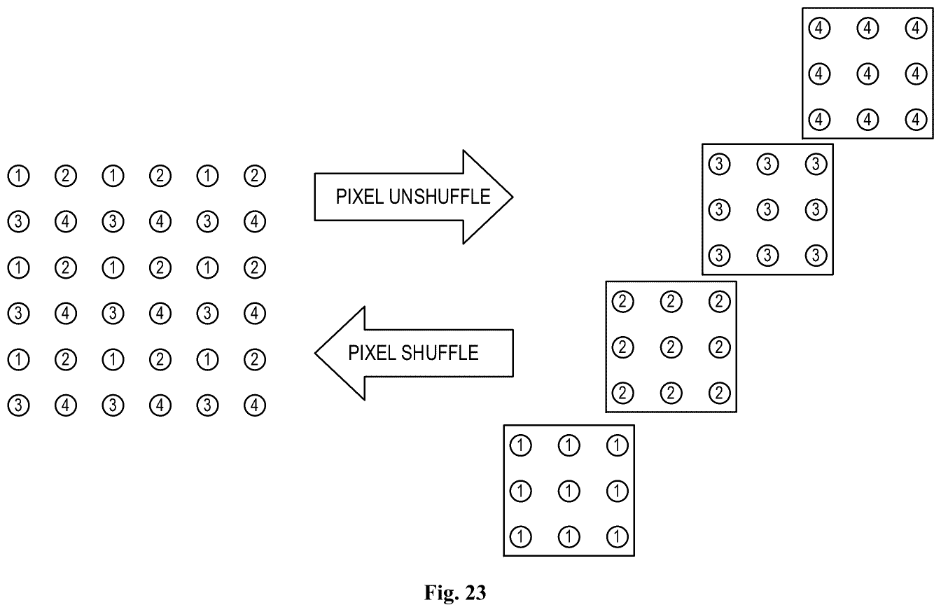

FIG. 23 illustrates an example of pixel shuffle and unshuffle operations. PixelShuffle is an operation used in super-resolution models to implement efficient sub-pixel convolutions with a stride of 1/r. Specifically it rearranges elements in a tensor of shape [Cxr2, W, H] to a tensor of shape [C, Wxr, Hxr].

Pixel unshuffled operation is the opposite of shuffle operation, wherein the input tensor with shape [C, Wxr, Hxr] is converted to a tensor with shape [Cxr2, W, H].

### 6.5 Deconvolution Operation

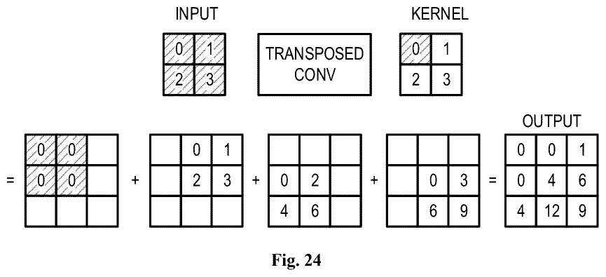

FIG. 24 illustrates an example transposed convolution operation with a 2×2 kernel. The shaded portions are a portion of an intermediate tensor as well as the input and kernel tensor elements used for the computation. A transposed convolutional (aka deconvolution) layer, is usually carried out for upsampling i.e. to generate an output feature map that has a spatial dimension greater than that of the input feature map.

### 6.6. Technical Problems Solved by Disclosed Technical Solutions

In some example neural network based codecs, an input image is first converted to luma, blue projections, and red projection (YUV)420 format. This means that the image is decomposed into 3 components (e.g. Y, U, and V), and then the chroma components are downsampled by a factor of 2. When the width and height of the luma component are W and H respectively, the width and height of the chroma components U and V are W/2 and H/2, respectively. At the end of the decoding process, the chroma components are upsampled back to the original size using an upsampling filter.

The upsampling filter may be a bicubic filter or a lanczos filter. Those filters may be complicated and not suitable for implementation in neural processing units (NPU). For example, a bicubic filter is simpler than the lancsos filter. The bicubic filter includes calculation of second order derivatives and calculation of the square and cube of the input. Derivative calculation and functions ƒ(x)=x² and ƒ(x)=x³ typically cannot be implemented in all NPU implementations. Therefore, bicubic interpolation may need to be performed on general purpose processing units such as central processing unit (CPU). This reduces the efficiency and speed of the codec.

Furthermore, when the components of the image, e.g., a luma component and a chroma component, are processed with different synthesis subnetworks, the correlations between the different components are not fully utilized. In other words, information that might be important for reconstruction of one component might also be relevant for the reconstruction of a second component too. This joint information cannot be fully utilized when 2 different synthesis transforms are utilized to reconstruct 2 different components.

### 6.7. A Listing of Solutions and Embodiments

### 6.7.1 Central Examples

This disclosure has the goal replacing upsampling operations performed in Neural network based codecs with a processing layer that is much more suited for implementation in Neural processing units. Furthermore, the quality of the upsampled component is improved by utilizing cross component correlations. In other words, the disclosure achieves the following two goals with a single neural network processing layer:
Replacing complicated upsampling operations with fundamental processing layers that are used in neural network implementations.
Improving the quality of the upsampled component using content adaptation and by utilizing cross component information.

### Decoder Operation:

According to some examples, a bitstream is converted to a reconstructed image using a neural network, comprising the following operations:
Obtaining a weight parameter from the bitstream,
[Optionally] Obtaining an offset value.
Obtaining an upsampled second component according to the following:
   Reducing the spatial size of a first component (e.g. by downsampling or pixel unshuffling).
   Processing the first component and the second component with a neural network layer and using the weight parameter and the offset value.
Obtaining the reconstructed image using the first component and the upsampled second component.

### Encoder Operation:

According to some examples, an image is converted to a bitstream using a neural network, comprising the following operations:
Obtaining/determining an offset value,
Obtaining an upsampled second component according to the any or all of the following:
   Reducing the spatial size of a first component (e.g. by downsampling or pixel unshuffling).
   Processing the first component and the second component with a neural network layer and using a candidate weight parameter and/or a candidate offset value.
   Calculating the weight parameter and the offset value that maximizes the quality of the reconstructed image.
Obtaining the reconstructed image using the first component and the upsampled second component.
Including the weight parameter and/or the offset value in a bitstream.

In one example, the first component is the Y in YCbCr color format, and the second component is the Cb or Cr component.

In one example, the first component is the G component in RGB color format and the second component is the B/R component.

In one example, two offsets and/or two weights may be signalled in the bitstream.
Alternatively, only one offset and/or one weight may be signalled in the bitstream, and the second/third component may share the same values.
Alternatively, predictive coding may be applied to code one of the two weights.
Alternatively, predictive coding may be applied to code one of the two offsets.

### 6.7.2 Details of the Examples

An example implementation may be as follows:

$${recU}_{upsampled} = pixelShuffle ( Conv 1 ( recU ) + Conv 2 ( {recY}_{downsized} ) ) \qquad ( 6 )$$

According to the equation, the first component (recY) is first downsized. The downsizing operation can be achieved either by downsampling, or pixel unshuffled operation. Afterwards the recY_{downsized} and the second component recU is fed into a convolution layer. In the equation (6), 2 convolution functions are shown. Since the output of the two convolution operations are added together, this process can be realized with a single convolution also. Finally, the output is processed with a pixelShuffle layer, wherein the size of the input [4, W/2, H/2] is changed to [1, W, H]. The W and H denote the width and height. As a result, recU_{upsampled} is obtained which has double the width and height of the input tensor.
A mean value might be subtracted from recU or recY or recY_{downsized} before inputting the two process. The mean value might be the mean value (average value) of the samples of recU or recY.
A mean value might be added to recU_{upsampied}. The mean value might be the mean value (average value) of the samples of recU or recY or recY_{downsized}.
Another example implementation may be as follows:

$$( 7 )$$

$${recU}_{upsampled} ( x , y ) = \{ \begin{matrix}\begin{matrix}Conv ( recU ( floor ( \frac{x}{2} ) , floor ( \frac{y}{2} ) ) ) + \\ Conv ( {recY}_{unshuffled} ( 1 , floor ( \frac{x}{2} ) , floor ( \frac{y}{2} ) ) ) , x is even , y is even\end{matrix} \\ \begin{matrix}Conv ( recU ( floor ( \frac{x}{2} ) , floor ( \frac{y}{2} ) ) ) + \\ Conv ( {recY}_{unshuffled} ( 2 , floor ( \frac{x}{2} ) , floor ( \frac{y}{2} ) ) ) , x is even , y is odd\end{matrix} \\ \begin{matrix}Conv ( recU ( floor ( \frac{x}{2} ) , floor ( \frac{y}{2} ) ) ) + \\ Conv ( {recY}_{unshuffled} ( 3 , floor ( \frac{x}{2} ) , floor ( \frac{y}{2} ) ) ) , x is odd , y is even\end{matrix} \\ \begin{matrix}Conv ( recU ( floor ( \frac{x}{2} ) , floor ( \frac{y}{2} ) ) ) + \\ Conv ( {recY}_{unshuffled} ( 4 , floor ( \frac{x}{2} ) , floor ( \frac{y}{2} ) ) ) , x is odd , y is odd\end{matrix}\end{matrix}$$

In the example equation above, the pixel unshuffled operation is used to obtain recY_{unshuffled} from recY. The size of the recY is [1, W, H], and the size of the recY_{unshuffled} is [4, W/2, H/2].
Depending on whether x and y are even or odd, the sample recU_{upsampled} (x, y) is obtained using different channels of the recY_{unshuffled}. The unshuffling process generates an output tensor that has 4 channels.
   If for example x and y are both even, recU and the first channel of recY_{unshuffled} are used as input.
   If for example x and y are both odd valued, recU and the fourth channel of recY_{unshuffled} are used as input.
In the equation (7), 2 convolution functions are shown, one of which processing the recU input, the other processing the recY_{unshuffled}. Since the output of the two convolution operations are added together, this process can also be realized with a single convolution.
Equation (7) above exemplifies how the upsampled component (recU_{upsampled}) might be obtained using the recU and the recY as inputs. The recU is the first component and the recY is the second component of the image. The recU_{upsampled} is the upsampled first component. Firstly, an unshuffled operation is performed to obtain recY_{unshuffled} from recY.
   When obtaining upsampled first component recU_{upsampled} (x, y), only the first channel of the recY_{unshuffled} might be used when x and y are both even valued.
   When obtaining upsampled first component recU_{upsampled} (x, y), only the second channel of the recY_{unshuffled} might be used when x is even and y is odd valued.
   Etc.
In the equation above the floor(x) function might describe the floor operation i.e. the output of the function is the integer that is closest to x and smaller than x.
A mean value might be subtracted from recU or recY or recY_{unshuffled} before inputting to the process. The mean value might be the mean value (average value) of the samples of recU or recY.
A mean value might be added to recU_{upsampled}. The mean value might be the mean value (average value) of the samples of recU or recY or recY_{unshuffled}.
Another example implementation might be as follows:

$$( 8 )$$

$${recU}_{upsampled} ( x , y ) = {\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} recY ( x + 2 * m , y + 2 * n ) * {W}_{2} [ m , n ] + K$$

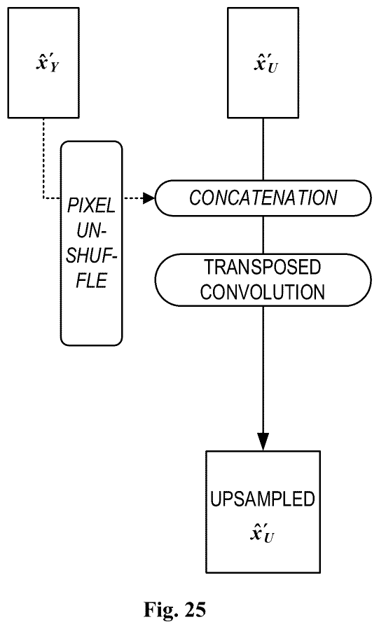

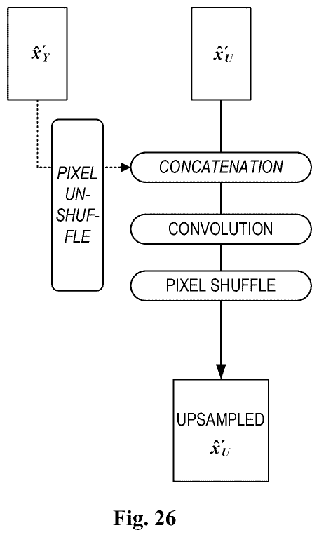

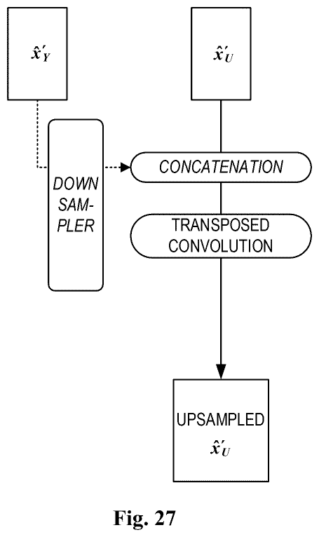

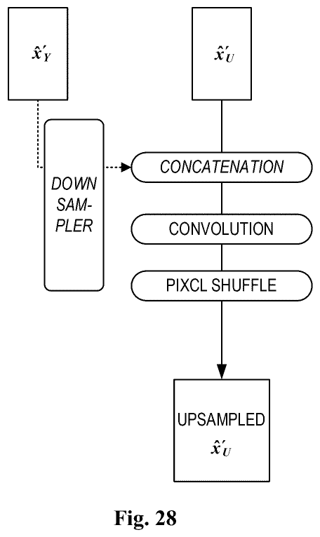

Equation (8) above exemplifies how the upsampled component (recU_{upsampled}) might be obtained using the recU and the recY as inputs. The recU is the first component and the recY is the second component of the image. The recU_{upsampled} is the upsampled first component. In equation (8), the convolution operation is depicted in open form. The W₁[i, j] is the weights of the first convolution operation and the W₂ [m, n] are the weights of the second convolution operation. K might represent the additive scalar that is part of the convolution operation (also known as the bias of the convolution).
A mean value might be subtracted from recU or recY before inputting to the process. The mean value might be the mean value (average value) of the samples of recU or recY.
A mean value might be added to recU_{upsampled}. The mean value might be the mean value (average value) of the samples of recU or recY.
K might be a vector of additive components. Or might be a scalar.
The values of the indices i, j, m, and n might be predetermined, or might depend on an indication included in the bitstream.
   A filter size or kernel size value might be obtained from the bitstream to indicate the possible values of i, j, m, or n. If the filter size is 4 for example, the values of any of the indices might be {−1, 0, 1, 2}. If filter size is 3 for example, the values of indices might be {−1, 0, 1}.
      A first filter size value might be used to indicate the possible values of i and j, and a second filter size value might be used to indicate the possible values of m and n.
      The first filter size value or the second filter size value might be included in the bitstream (or obtained from).
It is noted that the following equation is equivalent to equation (8):

$$( 9 )$$

$${recU}_{upsampled} ( x , y ) = {\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} recY ( x + 2 * m + A , y + 2 * n + B ) * {W}_{2} [ m , n ] + K$$

where A and B are 0 or 1 or −1.
The above equation exemplifies different subsampling positions for first component. In some cases, it might be beneficial to use different positions of the second component (recY) when obtaining the upsampled first component (recU). In order to achieve this, an offset (A and/or B) might be added to the index of the second component as in equation (9).
Another example implementation might be depicted in FIGS. 25, 26, 27, and 28. FIG. 25 illustrates an example subnetwork of a neural network. FIG. 26 illustrates an example subnetwork of a neural network. FIG. 27 illustrates an example subnetwork of a neural network. FIG. 28 illustrates an example subnetwork of a neural network. In the figures, the \hat{x}′_{Y} depict the second component and the \hat{x}′_{U} depict the first component. Firstly, the \hat{x}′_{Y} processed with an operation that reduces its spatial dimensions. The operation might be a downsampling operation or an unshuffling operation. Afterwards the first component and the second component are processed with a convolution operation followed pixel shuffle operation or a transposed convolution operation.
The weight value might be implemented as part of a convolution function.
The offset value might be implemented as part of a convolution function. More specifically the offset value might be implemented as the bias value of a convolution function.
The first component (or the second component) might be a luma or a luminance component of an image.
The second (or the first component) component might be a U-chroma component, or a V-chroma component, or a chroma component or a chrominance component.
According to the disclosure the multiplicative weight values might be included in a bitstream at the encoder or obtained from a bitstream at the decoder.
   In equations (6) to (9), or the FIGS. 25 to 28, the convolution weight values might be obtained from the bitstream.
According to the disclosure the additive offset values (or bias values) might be obtained from a bitstream.
   In equations (6) to (9), or the FIGS. 25 to 28, the convolution bias values might be obtained from the bitstream.
The weight or offset values might be obtained according to a maximum value and/or a minimum value.
   The maximum value might be the maximum value of the samples of the first component.
   The minimum value might be the minimum value of the samples of the first component.
   The maximum or the minimum value might be obtained from a bitstream.
   The offset value might be obtained according to a value N that is used to divide the difference of the maximum and the minimum value.
      The N might be predefined or might be obtained from a bitstream.
   The offset values 1 . . . N might be obtained as follows:

$$Offset [ n ] = \frac{maximum\_value - minimum\_value}{N} * n + minimum\_value ,$$

$$wherein n and N are integer values .$$

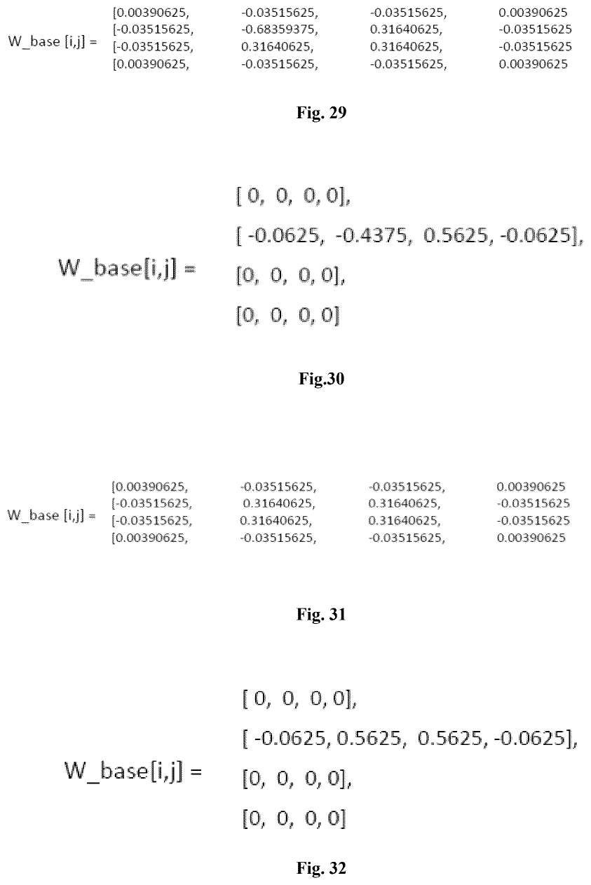

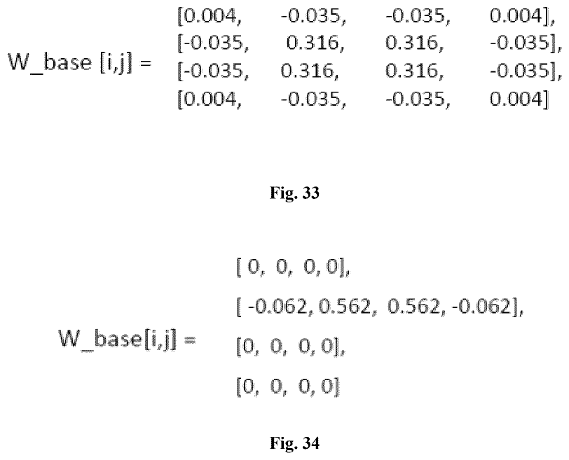

The weight values or the bias values of the convolution operation might be included in the bitstream as difference to a predetermined base value. The weight values W[i,j] of a convolution operation might be obtained as:
   W[i, j]=W_base[i,j]+W_signalled[i,j], wherein the W_base[i,j] are the predetermined weights values and the W_signalled [i,j] might be obtained from the bitstream.
   The values of the W_base might be as depicted in FIG. 29 or 30. FIG. 29 illustrates an example of W_base[i,j] values. FIG. 30 illustrates an example of W_base[i,j] values.
   The values of the W_base might be as depicted in FIG. 31 or 32. FIG. 31 illustrates an example of W_base[i,j] values. FIG. 32 illustrates an example of W_base[i,j] values. The difference between the FIGS. 31 and 29 is as follows. In FIGS. 29 and 30, the sum of the values of the weights W_base[i,j] add up to 0. Whereas in FIGS. 31 and 32, the sum of the values of the weights W_base[i,j] add up to 1. The 2 convolution kernels are equivalent. In FIGS. 29 and 30, the non-filtered input is added to the output after filtering.
   The values of the W_base[i,j] might be as depicted in FIG. 33 or 34. FIG. 33 illustrates an example of W_base[i,j] values. FIG. 34 illustrates an example of W_base[i,j] values. FIGS. 33 and 34 are very similar and exemplify the fact that the precision of the weights of W_base[i,j] might be adjusted. In FIGS. 33 and 34, the precision that is used is 3 digits after the decimal point. It can be increased or reduced.
   The sum of the values of the W_base[i,j] add up to 0 or 1.
The first component, or second component, or any component mentioned above might be a component of an image.
   It might be a chroma component, or a luma component.
   A mean value might be subtracted from any of the components before the application of the proposed solution.
   After the application of the proposed solution, a mean value might be added to the upsampled component.

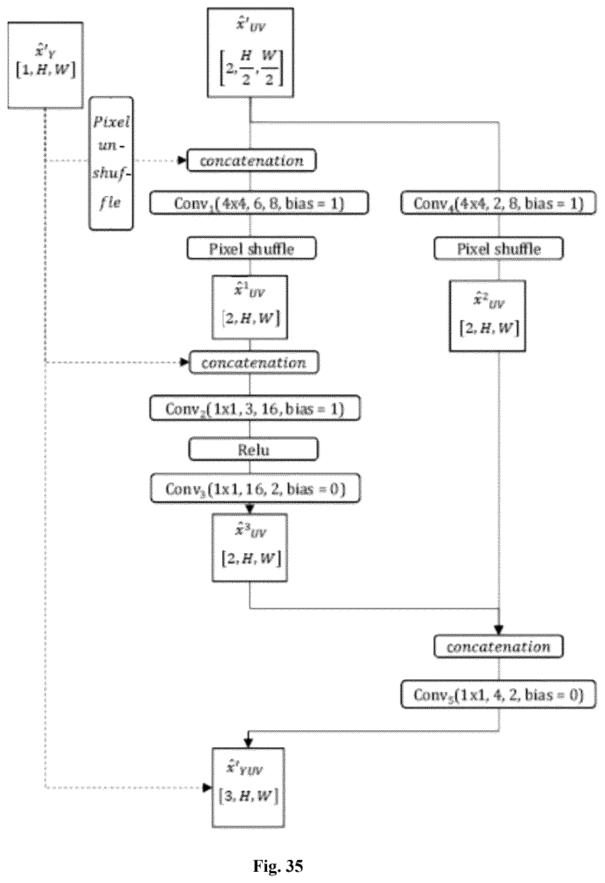

FIG. 35 illustrates an example neural network.

### 6.7.3. Explanation and the Benefits of the Examples

The examples improve the quality of a reconstructed image using parameters that are obtained from a bitstream. The examples are designed in such a way that the following benefits are achieved:
1. Some of the parameters that are used in the equation are obtained from the bitstream. This provides the possibility of content adaptation. In neural network-based image compression networks, the network may be trained beforehand using a very large dataset. After the training is complete, the network parameters (e.g. weights and/or bias values) cannot be adjusted. However, when the network is used, it is used on an completely new image that is not part of the training dataset. Therefore, a discrepancy between training dataset and the real-life image exists. In order to solve this problem, a small set of parameters that are optimized for the new image is transmitted to the decoder to improve the adaptation to the new content.
   A second benefit of including the parameters in the bitstream is, when the parameters are transmitted, a much shorter network can be used to serve the same purpose. In other words, if the parameters are not transmitted as side information, a much longer neural network (comprising many more convolution and activation layers) might have been necessary to achieve the same purpose.
2. The examples can be implemented using the most basic neural network layers. The equations that are used to explain the examples are designed in such a way that they are implementable using the most fundamental processing layers in the neural network literature, namely convolution and relu operations. The reason for this intentional choice is that, an image coder/decoder is expected to be implemented in a wide variety of devices, including mobile phones. It is important that an image encoded in one device is decodable in nearly all devices. Although the neural processing chipsets or GPUs in such devices are getting more and more sophisticated, it is still not possible to implement an arbitrary function on such processing units. As a simple example, the function ƒ(x)=x², though looking very simple, cannot be efficiently implemented in a neural processing unit and, can only be implemented in a general purpose processing unit such as CPU. If a function is not implementable in neural processing unit, the processing speed and battery consumption is greatly increased.
   The examples eliminate the above problem by using the most fundamental processing layers in neural network literature. The convolution and relu (and some other activation functions like leaky relu, sigmoid etc), are nearly guaranteed to be implemented in neural processing units or GPUs. Therefore, a mobile phone having a neural processing unit or a GPU is expected to perform the defined operation efficiently.
3. The examples utilizes the cross-component information to improve a component of the image. In some neural network-based image compression methods, the reconstructed chroma components (e.g. U-component of the V-component) might have a smaller size than the luma (Y-component) after reconstruction at the encoder or decoder. The reason is that, the chroma components carry information that is less relevant to human visual consumption, and therefore a smaller chroma component is typically encoded by the encoder and transmitted to the decoder. As a result the output of an image compression network might consist of a luma component and half-sized chroma component.
   The upsampling methods such as bicubic upsampling or using a fixed upsampling filter can normally not create a high quality chroma component, since:
      The filter coefficients are not content adaptive. A fixed filtering method is not always the best filter for each content.
      Ignores the cross-component correlations.
   According to the examples, the quality of a component is improved, therefore the reconstructed image is closer to the original image, which is the goal of a good codec. The examples achieve this by utilizing the information included in one component to improve the quality of a second component.
   More specifically the examples utilize the information in luma component in the upsampling process of the chroma component. The additional information improves the quality of the upsampled component.

### Enhancement Filtering Extension (EFE) Layers

### I.1 General

This section details the Enhancement Filtering Extension Layers (EFE) process. This process provides enhancement of colour information planes (secondary components) of image utilizing information from brightness (primary component).

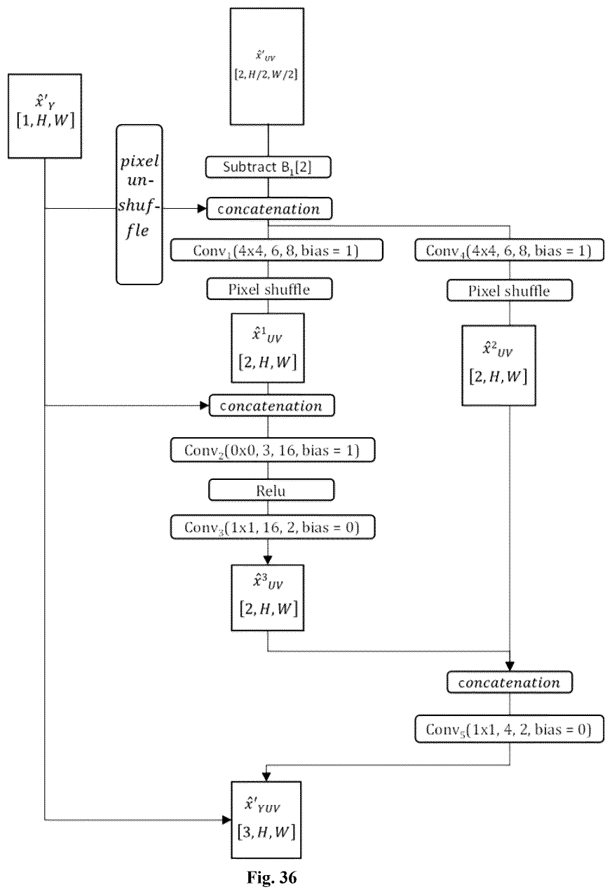

FIG. 36 illustrates an example implementation of enhancement filtering extension layers.

### I.2 EFE General Process

EFE process receives reconstructed secondary \tilde{\hat{x}}_{UV}[2, H_{UV}, W_{UV}] and reconstructed primary \tilde{\hat{x}}_{Y}[2, H_{Y}, W_{Y}] components as inputs. The output of EFE process is full-sized enhanced \hat{x}′_{YUV} [3, H, W] tensor, which is used as input to ICCI process.

Firstly, the following assignments are performed:
H is set equal to H_{UV}*2 and W is set equal to W_{UV}*2.
Samples of \hat{x}′_{UV}[2, H/2, W/2] is set equal to \tilde{\hat{x}}_{UV}[2, H/2, W/2].
Samples of \hat{x}′_{Y}[1, H, W] is set equal to \tilde{\hat{x}}_{Y}[2, H, W].

The following ordered steps are performed:
Parameters signalling and reconstruction process as specified in section I.3 is invoked with picture header as input and tensors W_{1A}, W_{1B}, W₃, W_{4A}, W_{4B}, W₅ and B₁ as output.
The EFE luma aided adaptive upsampling process (section I.2.1) is invoked with \hat{x}′_{UV}[2, H/2, W/2] and \hat{x}′_{Y}[1, H, W] as inputs and \hat{x}¹_{UV}[2, H, W] as output.
The EFE luma aided nonlinear filtering process (section I.2.2) is invoked with \hat{x}¹_{UV}[2, H, W] and \hat{x}′_{Y}[1, H, W] as inputs and \hat{x}³_{UV}[2, H, W] as output.
The EFE output adjustment process (section I.2.3) is invoked with \hat{x}³_{UV}[2, H, W], \hat{x}′_{UV}[2, H/2, W/2] and \hat{x}′_{YUV}[1, H, W] as inputs and \hat{x}′_{YUV}[3, H, W] as output.

The tensor \hat{x}′_{YUV} [3, H, W] is modified by cropping from bottom and right sides to obtain the target size of \hat{x}′_{YUV}[3, H_{Y}, W_{Y}]. NOTE—INFORMATIVE: FIG. 36 depicts an example implementation of the EFE using processing layers that are typical such as convolution, concatenation, Relu and pixel shuffle.

### I.2.1 EFE Luma Aided Adaptive Upsampling Process

The input of this process are \hat{x}′_{UV}[2, H/2, W/2] and \hat{x}′_{Y}[1, H, W].

Output of this process is \hat{x}¹_{UV}[2, H, W].

The multiplicative weight parameters W_{1A}[cand[best_cand_u_idx2][1],8,4,4] and W_{1B}[cand[best_cand_u_idx2][1],8,4,4] are used that are obtained according to section I.3.

The additive bias parameter B₁[2] is used that is obtained according to section I.3.

Firstly the input tensors are updated by padding with zero samples as follows:
\hat{x}′_{UV} is padded 1 sample to the left and top, and 2 samples to the right and bottom.
\hat{x}′_{Y} is padded 2 sample to the left and top, and 4 samples to the right and bottom.
For x in 0 . . . W−1, y in 0 . . . H−1, and k in 0 . . . 1 the following is performed;

$${\hat{x}}_{UV}^{1} ( k , y , x ) = {\sum }_{j = - 1}^{2} {\sum }_{i = - 1}^{2} \text{} \begin{matrix}( {\hat{x}}_{UV}^{′} ( k , floor ( \frac{y}{2} ) + i , floor ( \frac{x}{2} ) + j ) - {B}_{1} [ k ] ) * \\ {W}_{1 A} [ Tile 1 [ y , x ] , fi , 1 + i , 1 + j ] + \\ {\hat{x}}_{Y}^{′} ( y + 2 * i , x + 2 * j ) * \\ {W}_{1 B} [ Tile 1 [ y , x ] , fi , 1 + i , 1 + j ]\end{matrix} + {B}_{1} [ k ]$$

$$Wherein fi = 4 * k + 2 * ( y \%2 ) + x ( \%2 ) .$$

### I.2.2 EFE Luma Aided Non-Linear Filtering Process

The input of this process are \hat{x}¹_{UV}[2, H, W] and \hat{x}′_{Y}[1, H, W]. Output of this process is \hat{x}³_{UV}[2, H, W].

The multiplicative weight parameters

$${W}_{3} [ \frac{candNum}{16} , 2 , 8 ]$$

is used that is obtained according to section I.3.

The additive bias parameter B₂[8] is obtained as follows:

$${B}_{2} [ n ] = \frac{n}{8} * max ( {\hat{x}}_{Y}^{′} [ 1 , H , W ] ) - \frac{( 8 - n )}{8} * min ( {\hat{x}}_{Y}^{′} [ 1 , H , W ] ) .$$

For x in 0 . . . W−1, y in 0 . . . H−1, and k in 0 . . . 1 the following is performed;

$${\hat{x}}_{UV}^{3} ( k , y , x ) = {\hat{x}}_{UV}^{1} ( k , y , x ) + {\sum }_{n = 0}^{7} {W}_{3} [ Tile 2 [ y , x ] , k , n ] * RELU ( {\hat{x}}_{Y}^{′} ( 1 , x , y ) + {B}_{2} [ n ] ) .$$

### I.2.3 EFE Output Adjustment

The input of this process are \hat{x}′_{UV}[2, H/2, W/2] and \hat{x}³_{UV}[2, H, W]. Output of this process is \hat{x}′_{YUV}[3, H, W].

The multiplicative weight parameters W_{4A}[1,8,4,4], W_{4B}[1,8,4,4] and

$${W}_{5} [ \frac{H}{bS} , \frac{W}{bS} , 2 ]$$

are used that are obtained according to section I.3.2.

The additive bias parameter B₁[2] is used that is obtained according to section I.3.

Firstly, the input tensors are updated by padding with zero samples as follows:
\hat{x}′_{UV} is padded 1 sample to the left and top, and 2 samples to the right and bottom.
\hat{x}′_{Y} is padded 2 sample to the left and top, and 4 samples to the right and bottom.

Firstly, for x in 0 . . . W−1, y in 0 . . . H−1, and k in 0 . . . 1 the following is performed;

$${\hat{x}}_{UV}^{2} ( k , y , x ) = {\sum }_{j = - 1}^{2} {\sum }_{i = - 1}^{2} \begin{matrix}( {\hat{x}}_{UV}^{′} ( k , floor ( \frac{y}{2} ) + i , floor ( \frac{x}{2} ) + j ) - {B}_{1} [ k ] ) * \\ {W}_{4 A} [ 0 , fi , 1 + i , 1 + j ] + \\ {\hat{x}}_{Y}^{′} ( y + 2 * i , x + 2 * j ) * {W}_{4 B} [ 0 , fi , 1 + i , 1 + j ]\end{matrix} + {B}_{1} [ k ]$$

$$Wherein fi = 4 * k + 2 * ( y \%2 ) + x ( \%2 ) .$$

Afterwards, for x in 0 . . . W−1, y in 0 . . . H−1, and k in 1 . . . 2 the following is performed;

$${\hat{x}}_{YUV}^{′} ( k , y , x ) = {\hat{x}}_{UV}^{2} ( k - 1 , y , x ) * {W}_{5} [ \frac{y}{bS} , \frac{x}{bS} , k - 1 ] + {\hat{x}}_{UV}^{3} ( k - 1 , y , x ) * ( 1 - {W}_{5} [ \frac{y}{bS} , \frac{x}{bS} , k - 1 ] ) ) / 2.$$

Finally following assignment is made for x in 0 . . . W−1, y in 0 . . . H−1;

$${\hat{x}}_{YUV}^{′} ( 0 , y , x ) = {\hat{x}}_{Y}^{′} ( 0 , y , x ) .$$

### I.3 Parameters Signalling and Reconstruction Process

In order to perform the processing steps described in sections I.1 and I.2, the adjustable weight, bias and offset parameters are signalled in the picture header.

The input to this process is the picture header. The output of the process are W_{1A}, W_{1B}, W₃, W_{4A}, W_{4B}, W₅ and B₁.
First decoding process based on the binarization scheme described in section I.3.1 is invoked. The output of this process are the parsed syntax elements and the parameter tensors W₃, W₅ and B₁.
Tiling process is as described in section I.3.5 is invoked with parsed syntax elements as inputs and Tile1 and Tile2 tensors as outputs.
Parameter reconstruction process as specified in section I.3.4 is invoked with parsed syntax elements as inputs and W_{1A}, W_{1B}, W_{4A}, W_{4B} as outputs.

### I.3.1 4-Tap DCT-IF Parameters

$$\begin{matrix}{W}_{b a s e} [ 4 , 4 , 4 ] = \\ [ \\ \begin{matrix}[ [ 0 , & 0 , & 0 , & 0 ] ,\end{matrix} \\ \begin{matrix}[ 0 , & 0 , & 0 , & 0 ] ,\end{matrix} \\ \begin{matrix}[ 0 , & 0 , & 0 , & 0 ] ,\end{matrix} \\ \begin{matrix}[ 0 , & 0 , & 0 , & 0 ] ] ,\end{matrix} \\ \\ [ \begin{matrix}[ 0 , & 0 , & 0 , & 0 ] ,\end{matrix} \\ \begin{matrix}[ - 0.0625 , & - 0.4375 , & 0.5625 , & - 0.0625 ] ,\end{matrix} \\ \begin{matrix}[ 0 , & 0 , & 0 , & 0 ] ,\end{matrix} \\ \begin{matrix}[ 0 , & 0 , & 0 , & 0 ] ] ,\end{matrix} \\ \\ \begin{matrix}[ [ 0 , & - 0.0625 , & 0 , & 0 ] ,\end{matrix} \\ \begin{matrix}[ 0 , & - 0.4375 , & 0 , & 0 ] ,\end{matrix} \\ \begin{matrix}[ 0 , & 0.5625 , & 0 , & 0 ] ,\end{matrix} \\ \begin{matrix}[ 0 , & - 0.0625 , & 0 , & 0 ] ] ,\end{matrix} \\ \\ [ [ 0.0390625 , - 0.03515625 , - 0.03515625 , 0.00390625 ] , \\ [ - 0.03515625 , - 0.68359375 , 0.31640625 , - 0.03515625 ] , \\ [ - 0.03515625 , 0.31640625 , 0.31640625 , - 0.03515625 ] , \\ \begin{matrix}[ 0.0390625 , - 0.03515625 , - 0.03515625 , & 0.00390625 ] ]\end{matrix} \\ ]\end{matrix}$$

I.3.2 Syntax Table

| EFE_parameters( ) { | Descriptor |
|---|---|
| EFE_enabled_flag | uf(1) |
| if (EFE_enabled_flag){ | |
| B₁[0] | uf(2¹⁵-1) |
| B₁[1] | uf(2¹⁵-1) |
| W1, best_cand_u_idx1, best_cand_u_idx1, flU1, flV1 = decodeFilters() | |
| W2, best_cand_u_idx2, best_cand_u_idx2, flU2, flV2 = decodeFilters() | |
| mask1_enabled_flag | uf(1) |
| mask2_enabled_flag | uf(1) |
| len_mask_1_x=0, len_mask_2_x = 0, len_mask_1_y = 0, len_mask_2_y = 0 | |
| if (mask1_enabled_flag OR mask2_enabled_flag){ | |
| bS | uf(2¹⁰-1) |
| len_mask | uf(2¹⁰-1) |
| len_mask_y | uf(2¹⁰-1) |
| if mask1_enabled_flag{ | uf(2¹⁰-1) |
| len_mask_1_x = len_mask_x | |
| len_mask_1_y = len_mask_y | |
| } | |
| if mask2_enabled_flag{ | |
| len_mask_2_x = len_mask_x | |
| len_mask_2_y = len_mask_y | |
| } | |
| } | |
| ***Initialize W₅ tensor to all zeros*** | |
| for (i = 0, i < len_mask_1_x, i++) | |
| for (j = 0, i < len_mask_1_y, j++) | |
| W₅[i, j, 0] | uf(2) |
| for (i = 0, i < len_mask_2_x, i++) | |
| for (j = 0, i < len_mask_2_y, j++) | |
| W₅[i, j, 1] | uf(2) |
| nonLinear_enabled_U_flag | uf(1) |
| nonLinear_enabled_V_flag | uf(1) |
| if (nonLinear_enabled_U_flag OR nonLinear_enabled_V_flag){ | |
| nonlinear_width | uf(2¹⁶) |
| nonlinear_height | uf(2¹⁶) |
| candNum | uf(2¹⁶) |
| if (nonLinear_enabled_U_flag) { | |
| for (i = 0, i < candNum, i++){ | |
| A1 | uf(maxSymbol) |
| ${W}_{3} [ \frac{i}{8} , 0 , i \% 8 ] = deinteger ( A 1 + minSymbol , wP )$ | |
| } | |
| } | |
| if (nonLinear_enabled_V_flag) { | |
| for (i = 0, i < candNum, i++){ | |
| A1 | uf(maxSymbol) |
| ${W}_{3} [ \frac{i}{8} , 1 , i \% 8 ] = deinteger ( A 1 + minSymbol , wP )$ | |
| } | |
| } | |
| } | |
| } | |
| decodeFilters( ) { | Descriptor |
| best_cand_u_idx | uf(15) |
| best_cand_v_idx | uf(15) |
| if(best_cand_u_idx > 0) | |
| fl_U | uf(9) |
| if(best_cand_u_idx > 0) | |
| fl_V | uf(9) |
| minSymbol | uf(2¹⁶-1) |
| maxSymbol | uf(2¹⁶-1) |
| ***Initialize W[2,8,8,4,4] tensor to all zeros*** | |
| for (comp = 0, comp < 2, comp++) | |
| for (luCh = 0, luCh < 2, luCh ++) | |
| for (idx = 0, idx < cand[best_cand_u_idx][1] , idx ++) | |
| for (ch = 0, i < 4, ch++) | |
| if (comp == 0) fl=fl_U else fl = fl_V | |
| offset = 1 - f1/2 | |
| for (i = 0, i < fl, i++) | |
| for (j = 0, j < fl, j++) | |
| A1 | uf(maxSymbol) |
| A2 | uf(maxSymbol) |
| W[luCh, idx, comp * 4 + ch, offset + i, offset + j] = | |
| deinteger(A1+minSymbol,wP) | |
| W[luCh, idx, comp * 4 + ch, offset + i, offset + j] = | |
| deinteger(A2+minSymbol,wP) | |
| } | |

The values of best_cand_u_idx and best_cand_v_idx are restricted to be 0 in the first invocation of decodeFilters( ).

The values of fl_U and fl_V are restricted to be 1 in the first invocation of decodeFilters( ).

### I.3.3 Parameter Semantics

best_cand_u_idx—the 4 bit non-negative integer value specifying the candidate index corresponding to the u-component (first one of the secondary components), indicating the number of tiles and the tile coordinates. It is used as input to cand [X][Y] table in section I.5.
best_cand_v_idx—the 4 bit non-negative integer value specifying the candidate index corresponding to the v-component (second one of the secondary components), indicating the number of tiles and the tile coordinates. It is used as input to cand [X][Y] table in section I.5.
fl_U—the 9-valued non-negative integer value specifying the kernel size.
fl_V—the 9-valued non-negative integer value specifying the kernel size.
W1—the 4-dimensinal tensor specifying the multiplier coefficients, e.g. weights.
W2—the 4-dimensinal tensor specifying the multiplier coefficients, e.g. weights.
bS—the 10 bit non-negative integer value specifying the block size of the EFE output adjustment subprocess.
minSymbol—the 17-bit non-negative integer value specifying the a value that is added to multiplier coefficients WU, WV and offset parameters C₁ and C₂.
maxSymbol—the 17-bit non-negative integer value specifying a maximum value that is used in the uf(decoding process of multiplier coefficients WU, WV and offset parameters C₁ and C₂.
mask1_enabled_flag—the 1-bit non-negative integer value specifying a if the values of len_mask_1_x and len_mask_1_y are zero or greater than zero.
mask2_enabled_flag—the 1-bit non-negative integer value specifying a if the values of len_mask_2_x and len_mask_2_y are zero or greater than zero.
len_mask_1_x—the 10 bit non-negative integer value specifying the number of elements in the vertical direction of the S₁ tensor.
len_mask_1_y—the 10 bit non-negative integer value specifying the number of elements in the horizontal direction of the S₁ tensor.
len_mask_2_x—the 10 bit non-negative integer value specifying the number of elements in the vertical direction of the S₂ tensor.
len_mask_2_y—the 10 bit non-negative integer value specifying the number of elements in the horizontal direction of the S₂ tensor.
B1—the 16 bit value specifying the bias (additive component).
S₁—the 3-valued non-negative integer specifying the multiplication coefficients of the output adjust₁ processing layer.
S₂—the 3-valued non-negative integer specifying the multiplication coefficients of the output adjust₂ processing layer.
C₁—the wP bit value specifying the additive offset parameters used in Mask & Offset₁ processing layer.
C₂—the wP bit value specifying the additive offset parameters used in Mask & Offset₂ processing layer.
nonLinear_enabled_U_flag—on/off switch for nonlinear filtering process of U component.
nonLinear_enabled_V_flag—on/off switch for nonlinear filtering process of V component.
nonlinear_width—width of the weight tensor of the nonlinear filtering process.
nonlinear_height—height of the weight tensor of the nonlinear filtering process.

### I.3.4 Parameter Reconstruction Process

Input of this process are syntax elements parsed from the picture header.

Output of this process are weight tensors W_{1A}, W_{1B}, W_{4A} and W_{4B}.

The weights W_{1A}, W_{1B} are obtained as follows:

For i=0 . . . 3, j=0 . . . 3, comp=0 . . . 1, ch=0 . . . 3 and cand=0 . . . cand[best_cand_u_idx2][1]−1 the following is performed;

$$\begin{matrix}{W}_{1 A} [ cand , comp * 4 + c h , i , j ] = W 1 [ 0 , cand , comp * 4 + c h , i , j ] + {W}_{b a s e} [ ch , i , 1 ] , \\ {W}_{1 B} [ cand , comp * 4 + c h , i , j ] = W 1 [ 1 , cand , comp * 4 + ch , i , j ] .\end{matrix}$$

The weights W_{4A}, W_{4B} are obtained as follows:

For i=0 . . . 3, j=0 . . . 3, comp=0 . . . 1, ch=0 . . . 3 and cand=0 . . . cand[best_cand_u_idx2][1]−1, the following is performed;

$$\begin{matrix}{W}_{4 A} [ cand , comp * 4 + c h , i , j ] = W 2 [ 0 , cand , comp * 4 + c h , i , j ] + {W}_{b a s e} [ ch , i , j ] , \\ {W}_{4 B} [ cand , comp * 4 + c h , i , j ] = W 2 [ 1 , cand , comp * 4 + ch , i , j ] .\end{matrix}$$

### I.3.5 Tiling Process

Inputs to this process the width and the height of the luma reconstructed tensor H and W.

Output of this process are Tile1 and Tile2 tensors.

```
For (y=0, y < H, x++)
  For (x=0, x < W, x++)
        Index = 0
  For (i=0, i<cand[best_cand_u_idx2][1],i++)
    If round(cand[best_cand_u_idx2][2+i][0]*H) < y and y ≤
  round(cand[best_cand_u_idx2][2+i][1]*H)
          If round(cand[best_cand_u_idx2][2+i][2]*W) <x and x ≤
round(cand[best_cand_u_idx2][2+i][3]*W)
          Index = i
  Tilel(y, x) = Index
For (y=0, y < H, x++)
  For (x=0, x < W, x++)
        Index = y / nonlinear_height * ((H + nonlinear_height -1)/ nonlinear_height) + x/
nonlinear_width
  Tile2(y, x) = Index
```

The cand[X][Y][4] table that is referred to in sections I.3 and I.4 include the number of tiles and the coordinates of the tiles.

| cand | | | | | | | |
|---|---|---|---|---|---|---|---|
| [X][Y] | Y = 1 | Y = 2 | Y = 3 | Y = 4 | Y = 5 | Y = 6 | Y = 7 |
| X = 0 | 0 | | | | | | |
| X = 1 | 1 | [0, 1, 0, 1] | | | | | |
| X = 2 | 2 | [0, 0.5, 0, | [0.5, 1, 0, 1] | | | | |
| | | 1] | | | | | |
| X = 3 | 2 | [0, 1, 0, | [0, 1, 0.5, | | | | |
| | | 0.5] | 1]] | | | | |
| X = 4 | 3 | [0, 1, 0, | [0, 1, 0.33, | [0, 1, 0.66, 1] | | | |
| | | 0.33] | 0.66] | | | | |
| X = 5 | 3 | [0, 0.33, 0, | [0.33, 0.66, | [0.66, 1, 0, 1] | | | |
| | | 1] | 0,1] | | | | |
| X = 6 | 4 | [0, 0.5, 0, | [0, 0.5, 0.5, | [0.5, 1, 0, 0.5] | [0.5, 1, 0.5, 1] | | |
| | | 0.5] | 1] | | | | |
| X = 7 | 6 | [0, 0.33, 0, | [0, 0.33, | [0.33, 0.66, 0, | [0.33, 0.66, | [0.66, 1, | [0.66, 1, |
| | | 0.5] | 0.5, 1] | 0.5] | 0.5, 1] | 0, 0.5] | 0.5, 1] |
| X = 8 | 6 | [0, 0.5, 0, | [0.5, 1, 0, | [0, 0.5, 0.33, | [0.5, 1, 0.33, | [0, 0.5, | [0.5, 1, |
| | | 0.33] | 0.33] | 0.66] | 0.66] | 0.66, 1] | 0.66, 1] |

More details of the embodiments of the present disclosure will be described below which are related to neural network-based visual data coding. As used herein, the term “visual data” may refer to a video, an image, a picture in a video, or any other visual data suitable to be coded.

As discussed above, in the existing design for neural network (NN)-based visual data coding, components of the image (e.g., a luma component and a chroma component) are processed with different synthesis subnetwork, the correlation between the different components are not fully utilized. In other words, information that is used for reconstruction of a component may be useful for reconstructing a further component too. However, in the existing design, such cross-component information is not utilized.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

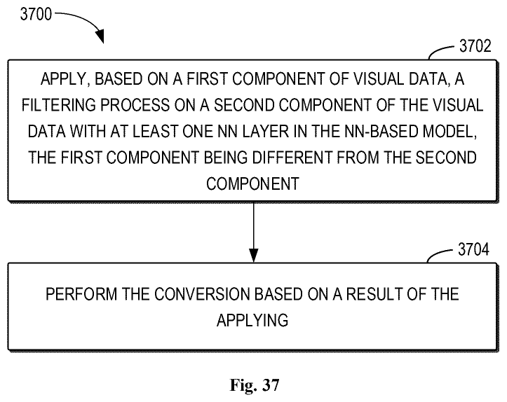

FIG. 37 illustrates a flowchart of a method 3700 for visual data processing in accordance with some embodiments of the present disclosure. The method 3700 may be implemented during a conversion between the visual data and a bitstream of the visual data, which is performed with a neural network (NN)-based model. As used herein, an NN-based model may be a model based on neural network technologies. For example, an NN-based model may specify sequence of neural network modules (also called architecture) and model parameters. The neural network module may comprise a set of neural network layers. Each neural network layer specifies a tensor operation which receives and outputs tensor, and each layer has trainable parameters. It should be understood that the possible implementations of the NN-based model described here are merely illustrative and therefore should not be construed as limiting the present disclosure in any way.

As shown in FIG. 37, the method 3700 starts at 3702, a filtering process is applied on a second component of the visual data with at least one NN layer in the NN-based model. The filtering process is applied based on a first component of the visual data, and the first component is different from the second component. By way of example rather than limitation, the filtering process may be an upsampling process. This will be described in detail below.

In one example, the second component may comprise a secondary component, and the first component may comprise a primary component. Alternatively, the second component may comprise a chroma component, and the first component may comprise a luma component. In a further example, the second component may comprise at least one of a U component or a V component, and the first component may comprise a Y component. It should be understood that the above examples are described merely for purpose of description. The scope of the present disclosure is not limited in this respect.

In some embodiments, the second component and the first component may be reconstructed with at least one synthesis transform in the NN-based model. By way of example rather than limitation, a synthesis transform may be a neural network that is used to convert a latent representation of the visual data from a transformed domain to a pixel domain. In one example, the second component and/or the first component may be directly output by the at least one synthesis transform. Alternatively, the second component and/or the first component may be obtained by further processing the output of the at least one synthesis transform. In some embodiments, the at least one synthesis transform may comprise a first synthesis transform and a second synthesis transform different from the first synthesis transform. The second component may be reconstructed with the first synthesis transform, and the first component may be reconstructed with the second synthesis transform. In this case, the second component and the first component are reconstructed with the at least one synthesis transform independently.

At 3704, the conversion is performed based on a result of the applying. By way of example rather than limitation, the visual data may be reconstructed based on the result of applying the filtering process. In some embodiments, the conversion may include encoding the visual data into the bitstream. Additionally or alternatively, the conversion may include decoding the visual data from the bitstream. It should be understood that the above illustrations are described merely for purpose of description. The scope of the present disclosure is not limited in this respect.

In view of the above, a filtering process is applied on a second component of the visual data based on a first component of the visual data. Compared with the conventional solution where the first and second components are processed independently, the proposed method can advantageously utilize the cross-component information to enhance the quality of the reconstructed visual data, and thus the coding quality can be improved.

In some embodiments, at 3702, the first component may be downsized. For example, the spatial size of the first component may be reduced. In one example, the first component may be downsized by applying a downsampling operation on the first component. Alternatively, the first component may be downsized by applying a unshuffle operation on the first component. As used herein, the unshuffle operation may also be referred to as a pixel unshuffle operation.

In addition, the second component may be adjusted based on the downsized first component to obtain the result of applying the filtering process. For example, an intermediate output may be obtained by processing the second component and the downsized first component with at least one convolutional layer in the at least one NN layer based on at least one weight and an offset. Moreover, an adjusted second component may be obtained by upsizing the intermediate output. By way of example rather than limitation, the intermediate output may be upsized by applying a shuffle operation on the intermediate output. As used herein, the shuffle operation may also be referred to as a pixel shuffle operation.

It should be noted that the adjusted second component is obtained based on an upsizing operation, and hence the size if the adjusted second component is larger than the original second component. In this regard, the above-described filtering process may also be regarded as an upsampling process. For example, a size of the second component may be [4, W/2, H/2], and a size of the result of applying the filtering process may be [1, W, H], each of W and H may be an integer.

In one example embodiment, the second component and the downsized first component may be processed based on the following:

$$C o n v 1 ( r e c U ) + C o n v 2 ( r e c {Y}_{d} ) ,$$

where recU represents the second component, recY_{d} represents the downsized first component, Conv1( ) represents a first convolution function, Conv2( ) represents a second convolution function. Since the output of the two convolution functions are added together, this process may also be realized with a single convolution function. In some embodiments, the result of this process may be upsized (e.g., with a shuffler operation) to obtain the adjusted second component.

In another example embodiment, depending on parity of coordinates of a first sample in the second component, a second sample in the intermediate output that corresponds to the first sample may be determined based on one of a plurality of channels of the downsized first component. By way of example rather than limitation, the plurality of channels comprise four channels. If the coordinates of the first sample are both even, the second sample may be determined based on a first channel among the four channels. If a first coordinate (such as a x-coordinate) of the first sample is even and a second coordinate (such as a y-coordinate) of the first sample is odd, the second sample may be determined based on a second channel among the four channels. If the first coordinate is odd and the second coordinate is even, the second sample may be determined based on a third channel among the four channels. If the coordinates of the first sample are both odd, the second sample may be determined based on a fourth channel among the four channels.

By way of example rather than limitation, the second component and the downsized first component may be processed based on the following:

$$\{ \begin{matrix}C o n v ( recU ( floor ( \frac{x}{2} ) , floor ( \frac{y}{2} ) ) ) + C o n v ( r e c {Y}_{d} ( 1 , floor ( \frac{x}{2} ) , floor ( \frac{y}{2} ) ) ) , x is even , y is even \\ C o n v ( r ecU ( floor ( \frac{x}{2} ) , floor ( \frac{y}{2} ) ) ) + C o n v ( r e c {Y}_{d} ( 2 , floor ( \frac{x}{2} ) , floor ( \frac{y}{2} ) ) ) , x is even , y is odd \\ C o n v ( r ecU ( floor ( \frac{x}{2} ) , floor ( \frac{y}{2} ) ) ) + C o n v ( r e c {Y}_{d} ( 3 , floor ( \frac{x}{2} ) , floor ( \frac{y}{2} ) ) ) , x is odd , y is even \\ C o n v ( r ecU ( floor ( \frac{x}{2} ) , floor ( \frac{y}{2} ) ) ) + C o n v ( r e c {Y}_{d} ( 4 , floor ( \frac{x}{2} ) , floor ( \frac{y}{2} ) ) ) , x is odd , y is odd\end{matrix} where$$

recU represents the second component, recY_{d} represents the downsized first component, x and y represent coordinates of a sample of the second component, Conv( ) represents a convolution function, floor( ) represents a floor function, an index 1 indicates the first channel of the downsized first component, an index 2 indicates the second channel of the downsized first component, an index 3 indicates the third channel of the downsized first component, and an index 4 indicates the fourth channel of the downsized first component. Since the output of the two convolution functions are added together, this process may also be realized with a single convolution function. In some embodiments, the result of this process may be upsized (e.g., with a shuffler operation) to obtain the adjusted second component.

In a further example embodiment, the second component and the downsized first component may be processed based on the following:

$${\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} r e c {Y}_{d} ( x + 2 * m , y + 2 * n ) * {W}_{2} [ m , n ] + K ,$$

where recU represents the second component, recY_{d} represents the downsized first component, x and y represent coordinates of a sample of the second component, floor( ) represents a floor function, each of W₁ and W₂ represents one of the at least one weight, K represents the offset, and a value range of i, j, k, or m may be dependent on a kernel size of the at least one convolutional layer. In some embodiments, the result of this process may be upsized (e.g., with a shuffler operation) to obtain the adjusted second component.

In a still further example embodiment, the second component and the downsized first component may be processed based on the following:

$${\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} r e c {Y}_{d} ( x + 2 * m + A , y + 2 * n + B ) * {W}_{2} [ m , n ] + K ,$$

where recU represents the second component, recY_{d} represents the downsized first component, x and y represent coordinates of a sample of the second component, floor( ) represents a floor function, each of W₁ and W₂ represents one of the at least one weight, K represents the offset, each of A and B may be an integer, and a value range of i, j, k, or m may be dependent on a kernel size of the at least one convolutional layer. In some embodiments, the result of this process may be upsized (e.g., with a shuffler operation) to obtain the adjusted second component.

In some embodiments, a kernel size of the at least one convolutional layer may be indicated in the one or more bitstreams. Alternatively, the kernel size may be predetermined. By way of example, if the kernel size is 4, the value range of i, j, k, or m may be {−1, 0, 1, 2}. If the kernel size may be 3, the value range of i, j, k, or m may be {−1, 0, 1}. It should be understood that the specific values recited herein are intended to be exemplary rather than limiting the scope of the present disclosure.

In some embodiments, the at least one weight may be indicated in the one or more bitstreams. For example, the at least one weight may be determined based on a maximum value and a minimum value. At least one of the maximum value or the minimum value may be indicated in the one or more bitstreams. By way of example rather than limitation, the maximum value may be indicated by a syntax element maxSymbol, and/or the minimum value may be indicated by a syntax element minSymbol.

In some embodiments, the at least one weight may be determined based on a first set of weights that is predetermined and a second set of weights that is obtained based on information indicated in the one or more bitstreams. In one example, the second set of weights itself may be indicated in the bitstream. Alternatively, the second set of weights may be determined based on one or more parameters that are indicated in the bitstream. In some embodiments, one of the first set of weights may be implemented as a 3×3 matrix, a 4×4 matrix, or the like. It should be understood that the weight matrix may be of any other suitable size.

In some embodiments, samples of one of the first set of weights may be all zeros. By way of example rather than limitation, each element of the 4×4 matrix may be equal to 0. Alternatively, samples of one or more the first set of weights may be obtained based on a predetermined vector. By way of example rather than limitation, the predetermined vector may be as follows: [−0.0625, −0.4375, 0.5625, −0.0625]. The predetermined vector may also be any other suitable vector. The scope of the present disclosure is not limited in this respect.

For example, one of the at least one weight may be determined by adding one of the first set of weights to one of the second set of weights. For example, W[i, j]=W_base[i,j]+W_signalled[i,j], wherein the W_base[i,j] are the predetermined weights values and the W_signalled [i,j] may be obtained from the bitstream.

In some embodiments, the second component may be divided into a first plurality of tiles, and the at least one weight may comprise different weights used for at least two of the plurality of tiles. For example, a tile may be a rectangular subblock of the corresponding component. It should be understood that the tile may also be of any other suitable shape. Additionally or alternatively, the downsized first component may be divided into a second plurality of tiles, and the at least one weight may comprise different weights used for at least two of the second plurality of tiles. That is, different tiles may be processed based on different weights. Thereby, the coding process can be adapted to content of the visual data, and thus the coding quality can be improved.

In some embodiments, the number of the first plurality of tiles and/or the number of the second plurality of tiles may be indicated by a candidate index. By way of example rather than limitation, the number of the first plurality of tiles is indicated by a syntax element best_cand_u_idx, which may be used as the candidate index.

In some embodiments, a kernel size of the at least one convolutional layer may be indicated in the bitstream if the candidate index has a value greater than 0. Additionally or alternatively, at least one of the following is obtained based on a candidate index and a predetermined table: the number of the first plurality of tiles, the number of the second plurality of tiles, coordinates of each tile in the first plurality of tiles, or coordinates of each tile in the second plurality of tiles. This is described in detail in the above section I.3.5 Tiling process.

In some embodiments, the number of the first plurality of tiles and/or the number of the second plurality of tiles may be indicated in the one or more bitstreams. Alternatively, the number of the first plurality of tiles and/or the number of the second plurality of tiles may be predetermined. In some embodiments, the number of the first plurality of tiles may be same as the number of the second plurality of tiles. Alternatively, the number of the first plurality of tiles may be different from the number of the second plurality of tiles. That is, the division schemes of different components may be different. Thereby, the coding process can be adapted to content of the visual data, and thus the coding quality can be improved.

In some embodiments, the offset used for processing the second component and the downsized first component may be indicated in the one or more bitstreams. By way of example, the offset may be indicated by a syntax element B1 in the one or more bitstreams. In one example, the offset may be equal to a mean value of samples of the second component.

In some embodiments, the at least one weight and/or the offset at least one of the following may be determined at an encoder. Moreover, the at least one weight and/or the offset may be transmitted from the encoder to the decoder. Thereby, the at least one weight and/or the offset are not fixed for the filtering process. In this regard, the filtering process may be an adaptive filtering process. Thereby, the coding process can be adapted to content of the visual data, and thus the coding quality can be improved.

In view of the above, the solutions in accordance with some embodiments of the present disclosure can advantageously utilize the cross-component information to enhance the quality of the reconstructed visual data, and thus the coding quality can be improved.

According to further embodiments of the present disclosure, a non-transitory computer-readable recording medium is provided. The non-transitory computer-readable recording medium stores a bitstream of visual data which is generated by a method performed by an apparatus for visual data processing. In the method, a filtering process is applied on a second component of the visual data with at least one NN layer in the NN-based model based on a first component of the visual data. The first component is different from the second component. In addition, the bitstream is generated based on a result of the applying.

According to still further embodiments of the present disclosure, a method for storing a bitstream of visual data is provided. In the method, a filtering process is applied on a second component of the visual data with at least one NN layer in the NN-based model based on a first component of the visual data. The first component is different from the second component. In addition, the bitstream is generated based on a result of the applying, and stored in a non-transitory computer-readable recording medium.

Implementations of the present disclosure can be described in view of the following clauses, the features of which can be combined in any reasonable manner.

Clause 1. A method for visual data processing, comprising: applying, based on a first component of visual data and for a conversion between the visual data and one or more bitstreams of the visual data with a neural network (NN)-based model, a filtering process on a second component of the visual data with at least one NN layer in the NN-based model, the first component being different from the second component; and performing the conversion based on a result of the applying.

Clause 2. The method of clause 1, wherein the filtering process comprises an upsampling process.

Clause 3. The method of any of clauses 1-2, wherein applying the filtering process comprises: downsizing the first component; and adjusting the second component based on the downsized first component to obtain the result of applying the filtering process.

Clause 4. The method of clause 3, wherein the first component is downsized by applying a downsampling operation or a unshuffle operation on the first component.

Clause 5. The method of any of clauses 3-4, wherein adjusting the second component comprises: obtaining an intermediate output by processing the second component and the downsized first component with at least one convolutional layer in the at least one NN layer based on at least one weight and an offset; and obtaining an adjusted second component by upsizing the intermediate output.

Clause 6. The method of clause 5, wherein the intermediate output is upsized by applying a shuffle operation on the intermediate output.

Clause 7. The method of any of clauses 1-6, wherein a size of the second component is [4, W/2, H/2], and a size of the result of applying the filtering process is [1, W, H], each of W and H is an integer.

Clause 8. The method of any of clauses 5-7, wherein depending on parity of coordinates of a first sample in the second component, a second sample in the intermediate output that corresponds to the first sample is determined based on one of a plurality of channels of the downsized first component.

Clause 9. The method of clause 8, wherein the plurality of channels comprise four channels, and if the coordinates of the first sample are both even, the second sample is determined based on a first channel among the four channels, or if a first coordinate of the first sample is even and a second coordinate of the first sample is odd, the second sample is determined based on a second channel among the four channels, or if the first coordinate is odd and the second coordinate is even, the second sample is determined based on a third channel among the four channels, or if the coordinates of the first sample are both odd, the second sample is determined based on a fourth channel among the four channels.

Clause 10. The method of any of clauses 5-9, wherein the second component and the downsized first component are processed based on the following: Conv1(recU)+Conv2(recY_{d}), where recU represents the second component, recY_{d} represents the downsized first component, Conv1( ) represents a first convolution function, Conv2( ) represents a second convolution function.

Clause 11. The method of any of clauses 5-10, wherein the second component and the downsized first component are processed based on the following:

$$\{ \begin{matrix}C o n v ( recU ( floor ( \frac{x}{2} ) , floor ( \frac{y}{2} ) ) ) + C o n v ( r e c {Y}_{d} ( 1 , floor ( \frac{x}{2} ) , floor ( \frac{y}{2} ) ) ) , x is even , y is even \\ C o n v ( r ecU ( floor ( \frac{x}{2} ) , floor ( \frac{y}{2} ) ) ) + C o n v ( r e c {Y}_{d} ( 2 , floor ( \frac{x}{2} ) , floor ( \frac{y}{2} ) ) ) , x is even , y is odd \\ C o n v ( r ecU ( floor ( \frac{x}{2} ) , floor ( \frac{y}{2} ) ) ) + C o n v ( r e c {Y}_{d} ( 3 , floor ( \frac{x}{2} ) , floor ( \frac{y}{2} ) ) ) , x is odd , y is even \\ C o n v ( r ecU ( floor ( \frac{x}{2} ) , floor ( \frac{y}{2} ) ) ) + C o n v ( r e c {Y}_{d} ( 4 , floor ( \frac{x}{2} ) , floor ( \frac{y}{2} ) ) ) , x is odd , y is odd\end{matrix} where$$

recU represents the second component, recY_{d} represents the downsized first component, x and y represent coordinates of a sample of the second component, Conv( ) represents a convolution function, floor( ) represents a floor function, an index 1 indicates the first channel of the downsized first component, an index 2 indicates the second channel of the downsized first component, an index 3 indicates the third channel of the downsized first component, and an index 4 indicates the fourth channel of the downsized first component.

Clause 12. The method of any of clauses 5-11, wherein the second component and the downsized first component are processed based on the following:

$${\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} r e c {Y}_{d} ( x + 2 * m , y + 2 * n ) * {W}_{2} [ m , n ] + K ,$$

where recU represents the second component, recY_{d} represents the downsized first component, x and y represent coordinates of a sample of the second component, floor( ) represents a floor function, each of W₁ and W₂ represents one of the at least one weight, K represents the offset, and a value range of i, j, k, or m is dependent on a kernel size of the at least one convolutional layer.

Clause 13. The method of any of clauses 5-12, wherein the second component and the downsized first component are processed based on the following:

$${\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} r e c {Y}_{d} ( x + 2 * m + A , y + 2 * n + B ) * {W}_{2} [ m , n ] + K ,$$

where recU represents the second component, recY_{d} represents the downsized first component, x and y represent coordinates of a sample of the second component, floor( ) represents a floor function, each of W₁ and W₂ represents one of the at least one weight, K represents the offset, each of A and B is an integer, and a value range of i, j, k, or m is dependent on a kernel size of the at least one convolutional layer.

Clause 14. The method of any of clauses 12-13, wherein if the kernel size is 4, the value range of i, j, k, or m is {−1, 0, 1, 2}, and if the kernel size is 3, the value range of i, j, k, or m is {−1, 0, 1}.

Clause 15. The method of any of clauses 5-14, wherein a kernel size of the at least one convolutional layer is indicated in the one or more bitstreams.

Clause 16. The method of any of clauses 5-15, wherein the at least one weight is indicated in the one or more bitstreams.

Clause 17. The method of any of clauses 5-15, wherein the at least one weight is determined based on a maximum value and a minimum value.

Clause 18. The method of clause 17, wherein at least one of the maximum value or the minimum value is indicated in the one or more bitstreams.

Clause 19. The method of clause 18, wherein the maximum value is indicated by a syntax element maxSymbol, or the minimum value is indicated by a syntax element minSymbol.

Clause 20. The method of any of clauses 5-19, wherein the at least one weight is determined based on a first set of weights that is predetermined and a second set of weights that is obtained based on information indicated in the one or more bitstreams.

Clause 21. The method of clause 20, wherein one of the at least one weight is determined by adding one of the first set of weights to one of the second set of weights.

Clause 22. The method of any of clauses 20-21, wherein one of the first set of weights is implemented as a 4×4 matrix.

Clause 23. The method of clause 22, wherein samples of one of the first set of weights are all zeros.

Clause 24. The method of clause 22, wherein samples of one of the first set of weights are obtained based on a vector as follows: [−0.0625, −0.4375, 0.5625, −0.0625].

Clause 25. The method of any of clauses 5-24, wherein the second component is divided into a first plurality of tiles, and the at least one weight comprises different weights used for at least two of the plurality of tiles, or the downsized first component is divided into a second plurality of tiles, and the at least one weight comprises different weights used for at least two of the second plurality of tiles.

Clause 26. The method of clause 25, wherein at least one of the following is indicated in the one or more bitstreams: the number of the first plurality of tiles, or the number of the second plurality of tiles.

Clause 27. The method of clause 26, wherein the number of the first plurality of tiles is indicated by a candidate index.

Clause 28. The method of clause 26, wherein the number of the first plurality of tiles is indicated by a syntax element best_cand_u_idx.

Clause 29. The method of clause 27, wherein a kernel size of the at least one convolutional layer is indicated in the bitstream if the candidate index has a value greater than 0.

Clause 30. the method of any of clauses 26-29, wherein at least one of the following is obtained based on a candidate index and a predetermined table: the number of the first plurality of tiles, the number of the second plurality of tiles, coordinates of each tile in the first plurality of tiles, or coordinates of each tile in the second plurality of tiles.

Clause 31. The method of any of clauses 25-30, wherein the number of the first plurality of tiles is different from the number of the second plurality of tiles.

Clause 32. The method of any of clauses 25-30, wherein the number of the first plurality of tiles is same as the number of the second plurality of tiles.

Clause 33. The method of any of clauses 5-32, wherein the offset is indicated in the one or more bitstreams.

Clause 34. The method of clause 33, wherein the offset is indicated by a syntax element B1 in the one or more bitstreams.

Clause 35. The method of any of clauses 5-34, wherein the offset is equal to a mean value of samples of the second component.

Clause 36. The method of any of clauses 5-35, wherein at least one of the following is determined at an encoder: the at least one weight, or the offset.

Clause 37. The method of any of clauses 1-36, wherein the second component and the first component are reconstructed with at least one synthesis transform in the NN-based model.

Clause 38. The method of clause 37, wherein the at least one synthesis transform comprise a first synthesis transform and a second synthesis transform different from the first synthesis transform, the second component is reconstructed with the first synthesis transform, and the first component is reconstructed with the second synthesis transform.

Clause 39. The method of any of clauses 1-38, wherein the second component comprises a secondary component, and the first component comprises a primary component, or wherein the second component comprises a chroma component, and the first component comprises a luma component, or wherein the second component comprises at least one of a U component or a V component, and the first component comprises a Y component.

Clause 40. The method of any of clauses 1-39, wherein performing the conversion comprises: reconstructing the visual data based on the result of applying the filtering process.

Clause 41. The method of any of clauses 1-40, wherein the filtering process is an adaptive filtering process.

Clause 42. The method of any of clauses 1-41, wherein the visual data comprise a video, a picture of the video, or an image.

Clause 43. The method of any of clauses 1-42, wherein the conversion includes encoding the visual data into the one or more bitstreams.

Clause 44. The method of any of clauses 1-42, wherein the conversion includes decoding the visual data from the one or more bitstreams.

Clause 45. An apparatus for visual data processing comprising a processor and a non-transitory memory with instructions thereon, wherein the instructions upon execution by the processor, cause the processor to perform a method in accordance with any of clauses 1-44.

Clause 46. A non-transitory computer-readable storage medium storing instructions that cause a processor to perform a method in accordance with any of clauses 1-44.

Clause 47. A non-transitory computer-readable recording medium storing a bitstream of visual data which is generated by a method performed by an apparatus for visual data processing, wherein the method comprises: applying, based on a first component of the visual data, a filtering process on a second component of the visual data with at least one NN layer in the NN-based model, the first component being different from the second component; and generating the bitstream based on a result of the applying.

Clause 48. A method for storing a bitstream of visual data, comprising: applying, based on a first component of the visual data, a filtering process on a second component of the visual data with at least one NN layer in the NN-based model, the first component being different from the second component; and generating the bitstream based on a result of the applying; and storing the bitstream in a non-transitory computer-readable recording medium.

### Example Device

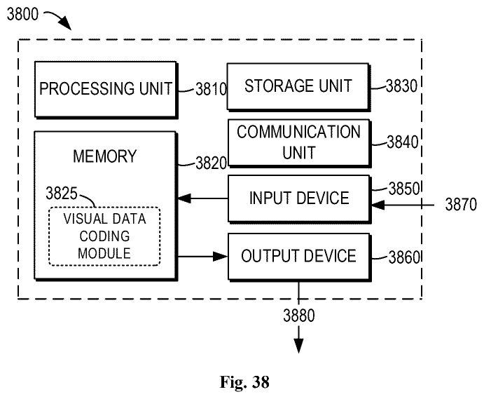

FIG. 38 illustrates a block diagram of a computing device 3800 in which various embodiments of the present disclosure can be implemented. The computing device 3800 may be implemented as or included in the source device 110 (or the visual data encoder 114) or the destination device 120 (or the visual data decoder 124).

It would be appreciated that the computing device 3800 shown in FIG. 38 is merely for purpose of illustration, without suggesting any limitation to the functions and scopes of the embodiments of the present disclosure in any manner.

As shown in FIG. 38, the computing device 3800 includes a general-purpose computing device 3800. The computing device 3800 may at least comprise one or more processors or processing units 3810, a memory 3820, a storage unit 3830, one or more communication units 3840, one or more input devices 3850, and one or more output devices 3860.

In some embodiments, the computing device 3800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3800 can support any type of interface to a user (such as “wearable” circuitry and the like).

The processing unit 3810 may be a physical or virtual processor and can implement various processes based on programs stored in the memory 3820. In a multi-processor system, multiple processing units execute computer executable instructions in parallel so as to improve the parallel processing capability of the computing device 3800. The processing unit 3810 may also be referred to as a central processing unit (CPU), a microprocessor, a controller or a microcontroller.

The computing device 3800 typically includes various computer storage medium. Such medium can be any medium accessible by the computing device 3800, including, but not limited to, volatile and non-volatile medium, or detachable and non-detachable medium. The memory 3820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3830 may be any detachable or non-detachable medium and may include a machine-readable medium such as a memory, flash memory drive, magnetic disk or another other media, which can be used for storing information and/or visual data and can be accessed in the computing device 3800.

The computing device 3800 may further include additional detachable/non-detachable, volatile/non-volatile memory medium. Although not shown in FIG. 38, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 3840 communicates with a further computing device via the communication medium. In addition, the functions of the components in the computing device 3800 can be implemented by a single computing cluster or multiple computing machines that can communicate via communication connections. Therefore, the computing device 3800 can operate in a networked environment using a logical connection with one or more other servers, networked personal computers (PCs) or further general network nodes.

The input device 3850 may be one or more of a variety of input devices, such as a mouse, keyboard, tracking ball, voice-input device, and the like. The output device 3860 may be one or more of a variety of output devices, such as a display, loudspeaker, printer, and the like. By means of the communication unit 3840, the computing device 3800 can further communicate with one or more external devices (not shown) such as the storage devices and display device, with one or more devices enabling the user to interact with the computing device 3800, or any devices (such as a network card, a modem and the like) enabling the computing device 3800 to communicate with one or more other computing devices, if required. Such communication can be performed via input/output (I/O) interfaces (not shown).

In some embodiments, instead of being integrated in a single device, some or all components of the computing device 3800 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3800 may be used to implement visual data encoding/decoding in embodiments of the present disclosure. The memory 3820 may include one or more visual data coding modules 3825 having one or more program instructions. These modules are accessible and executable by the processing unit 3810 to perform the functionalities of the various embodiments described herein.

In the example embodiments of performing visual data encoding, the input device 3850 may receive visual data as an input 3870 to be encoded. The visual data may be processed, for example, by the visual data coding module 3825, to generate an encoded bitstream. The encoded bitstream may be provided via the output device 3860 as an output 3880.

In the example embodiments of performing visual data decoding, the input device 3850 may receive an encoded bitstream as the input 3870. The encoded bitstream may be processed, for example, by the visual data coding module 3825, to generate decoded visual data. The decoded visual data may be provided via the output device 3860 as the output 3880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

We claim:

1. A method for visual data processing, comprising:
applying, based on a first component of visual data and for a conversion between the visual data and one or more bitstreams of the visual data with a neural network (NN)-based model, a filtering process on a second component of the visual data with at least one NN layer in the NN-based model, the first component being different from the second component; and
performing the conversion based on a result of the applying.

2. The method of claim 1, wherein the filtering process comprises an upsampling process, or wherein a size of the second component is [4, W/2, H/2], and a size of the result of applying the filtering process is [1, W, H], each of W and H is an integer.

3. The method of claim 1, wherein applying the filtering process comprises:
downsizing the first component; and
adjusting the second component based on the downsized first component to obtain the result of applying the filtering process,
wherein the first component is downsized by applying a downsampling operation or a unshuffle operation on the first component.

4. The method of claim 3, wherein adjusting the second component comprises:
obtaining an intermediate output by processing the second component and the downsized first component with at least one convolutional layer in the at least one NN layer based on at least one weight and an offset; and
obtaining an adjusted second component by upsizing the intermediate output,
wherein the intermediate output is upsized by applying a shuffle operation on the intermediate output.

5. The method of claim 4, wherein depending on parity of coordinates of a first sample in the second component, a second sample in the intermediate output that corresponds to the first sample is determined based on one of a plurality of channels of the downsized first component.

6. The method of claim 5, wherein the plurality of channels comprise four channels, and
if the coordinates of the first sample are both even, the second sample is determined based on a first channel among the four channels, or
if a first coordinate of the first sample is even and a second coordinate of the first sample is odd, the second sample is determined based on a second channel among the four channels, or
if the first coordinate is odd and the second coordinate is even, the second sample is determined based on a third channel among the four channels, or
if the coordinates of the first sample are both odd, the second sample is determined based on a fourth channel among the four channels.

7. The method of claim 5, wherein the second component and the downsized first component are processed based on the following:
$$C o n v 1 ( r e c U ) + C o n v 2 ( r e c {Y}_{d} ) ,$$
where recU represents the second component, recY_{d} represents the downsized first component, Conv1( ) represents a first convolution function, Conv2( ) represents a second convolution function, or
wherein the second component and the downsized first component are processed based on the following:
$$\{ \begin{matrix}C o n v ( recU ( floor ( \frac{x}{2} ) , floor ( \frac{y}{2} ) ) ) + C o n v ( r e c {Y}_{d} ( 1 , floor ( \frac{x}{2} ) , floor ( \frac{y}{2} ) ) ) , x is even , y is even \\ C o n v ( r ecU ( floor ( \frac{x}{2} ) , floor ( \frac{y}{2} ) ) ) + C o n v ( r e c {Y}_{d} ( 2 , floor ( \frac{x}{2} ) , floor ( \frac{y}{2} ) ) ) , x is even , y is odd \\ C o n v ( r ecU ( floor ( \frac{x}{2} ) , floor ( \frac{y}{2} ) ) ) + C o n v ( r e c {Y}_{d} ( 3 , floor ( \frac{x}{2} ) , floor ( \frac{y}{2} ) ) ) , x is odd , y is even \\ C o n v ( r ecU ( floor ( \frac{x}{2} ) , floor ( \frac{y}{2} ) ) ) + C o n v ( r e c {Y}_{d} ( 4 , floor ( \frac{x}{2} ) , floor ( \frac{y}{2} ) ) ) , x is odd , y is odd\end{matrix} where$$
where recU represents the second component, recY_{d} represents the downsized first component, x and y represent coordinates of a sample of the second component, Conv( ) represents a convolution function, floor( ) represents a floor function, an index 1 indicates the first channel of the downsized first component, an index 2 indicates the second channel of the downsized first component, an index 3 indicates the third channel of the downsized first component, and an index 4 indicates the fourth channel of the downsized first component, or
wherein the second component and the downsized first component are processed based on the following:
$${\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} r e c {Y}_{d} ( x + 2 * m , y + 2 * n ) * {W}_{2} [ m , n ] + K ,$$
where recU represents the second component, recY_{d} represents the downsized first component, x and y represent coordinates of a sample of the second component, floor( ) represents a floor function, each of W₁ and W₂ represents one of the at least one weight, K represents the offset, and a value range of i, j, k, or m is dependent on a kernel size of the at least one convolutional layer, or
wherein the second component and the downsized first component are processed based on the following:
$${\sum }_{j} {\sum }_{i} recU ( floor ( \frac{x}{2} ) + i , floor ( \frac{y}{2} ) + j ) * {W}_{1} [ i , j ] + {\sum }_{m} {\sum }_{n} r e c {Y}_{d} ( x + 2 * m + A , y + 2 * n + B ) * {W}_{2} [ m , n ] + K ,$$
where recU represents the second component, recY_{d} represents the downsized first component, x and y represent coordinates of a sample of the second component, floor( ) represents a floor function, each of W₁ and W₂ represents one of the at least one weight, K represents the offset, each of A and B is an integer, and a value range of i, j, k, or m is dependent on a kernel size of the at least one convolutional layer.

8. The method of claim 7, wherein if the kernel size is 4, the value range of i, j, k, or m is {−1, 0, 1, 2}, and
if the kernel size is 3, the value range of i, j, k, or m is {−1, 0, 1}.

9. The method of claim 4, wherein a kernel size of the at least one convolutional layer is indicated in the one or more bitstreams, or
wherein the at least one weight is indicated in the one or more bitstreams, or
wherein the at least one weight is determined based on a maximum value and a minimum value, and wherein at least one of the maximum value or the minimum value is indicated in the one or more bitstreams, or the maximum value is indicated by a syntax element maxSymbol, or the minimum value is indicated by a syntax element minSymbol.

10. The method of claim 4, wherein the at least one weight is determined based on a first set of weights that is predetermined and a second set of weights that is obtained based on information indicated in the one or more bitstreams.

11. The method of claim 10, wherein one of the at least one weight is determined by adding one of the first set of weights to one of the second set of weights, or
wherein one of the first set of weights is implemented based on a 4×4 matrix, and wherein samples of one of the first set of weights are all zeros, or samples of one of the first set of weights are obtained based on a vector as follows: [−0.0625, 0.5625, 0.5625, −0.0625].

12. The method of claim 4, wherein the second component is divided into a first plurality of tiles, and the at least one weight comprises different weights used for at least two of the plurality of tiles, or the downsized first component is divided into a second plurality of tiles, and the at least one weight comprises different weights used for at least two of the second plurality of tiles.

13. The method of claim 12, wherein at least one of the following is indicated in the one or more bitstreams:
the number of the first plurality of tiles, or
the number of the second plurality of tiles.

14. The method of claim 13, wherein the number of the first plurality of tiles is indicated by a candidate index, and a kernel size of the at least one convolutional layer is indicated in the bitstream if the candidate index has a value greater than 0, or
wherein at least one of the following is obtained based on a candidate index and a predetermined table:
the number of the first plurality of tiles, the number of the second plurality of tiles, coordinates of each tile in the first plurality of tiles, or coordinates of each tile in the second plurality of tiles, or
wherein the number of the first plurality of tiles is different from the number of the second plurality of tiles, or
wherein the number of the first plurality of tiles is same as the number of the second plurality of tiles.

15. The method of claim 5, wherein the offset is indicated in the one or more bitstreams, or
wherein the offset is indicated by a syntax element B1 in the one or more bitstreams, or
wherein the offset is equal to a mean value of samples of the second component, or
wherein at least one of the following is determined at an encoder: the at least one weight, or the offset.

16. The method of claim 1, wherein the second component and the first component are reconstructed with at least one synthesis transform in the NN-based model, the at least one synthesis transform comprise a first synthesis transform and a second synthesis transform different from the first synthesis transform, the second component is reconstructed with the first synthesis transform, and the first component is reconstructed with the second synthesis transform, or
wherein the second component comprises a secondary component, and the first component comprises a primary component, or
wherein the second component comprises a chroma component, and the first component comprises a luma component, or
wherein the second component comprises at least one of a U component or a V component, and the first component comprises a Y component, or
wherein performing the conversion comprises: reconstructing the visual data based on the result of applying the filtering process, or
wherein the filtering process is an adaptive filtering process, or
wherein the visual data comprise a video, a picture of the video, or an image.

17. The method of claim 1, wherein the conversion includes encoding the visual data into the one or more bitstreams, or
wherein the conversion includes decoding the visual data from the one or more bitstreams.

18. An apparatus for visual data processing comprising a processor and a non-transitory memory with instructions thereon, wherein the instructions upon execution by the processor, cause the processor to perform acts comprising:
applying, based on a first component of visual data and for a conversion between the visual data and one or more bitstreams of the visual data with a neural network (NN)-based model, a filtering process on a second component of the visual data with at least one NN layer in the NN-based model, the first component being different from the second component; and
performing the conversion based on a result of the applying.

19. A non-transitory computer-readable storage medium storing instructions that cause a processor to perform acts comprising:
applying, based on a first component of visual data and for a conversion between the visual data and one or more bitstreams of the visual data with a neural network (NN)-based model, a filtering process on a second component of the visual data with at least one NN layer in the NN-based model, the first component being different from the second component; and
performing the conversion based on a result of the applying.

20. A non-transitory computer-readable recording medium storing a bitstream of visual data which is generated by a method performed by an apparatus for visual data processing, wherein the method comprises:
applying, based on a first component of the visual data, a filtering process on a second component of the visual data with at least one NN layer in a neural network (NN)-based model, the first component being different from the second component; and
generating the bitstream with the NN-based model based on a result of the applying.
